(19) United States
(12) Patent Application Publication
(10) Pub. No.: US 2026/0319288 A1
(43) Pub. Date: Oct. 15, 2026

(54) LIQUID CRYSTAL DISPLAY PANEL AND DISPLAY DEVICE

(71) Applicant: Sharp Display Technology Corporation, Kameyama City, Mie (JP)

(72) Inventor: Junichi MORINAGA, Kameyama City (JP)

(21) Appl. No.: 19/570,340

(22) Filed: Mar. 18, 2026

(30) Foreign Application Priority Data
Mar. 21, 2025 (JP) 2025-046727

(51) Int. Cl. G02F 1/1335; G02B 30/33; G02F 1/1343; G02F 1/1347; G02F 1/1362

(52) U.S. Cl. CPC G02F 1/133512; G02B 30/33; G02F 1/134336; G02F 1/13439; G02F 1/1347; G02F 1/136286

(57) ABSTRACT

A liquid crystal display panel comprises a plurality of pixel electrodes arranged in a matrix in a first direction and a second direction intersecting with the first direction in a plan view; a liquid crystal layer; and a black matrix provided with a plurality of opening portions overlapping with the plurality of pixel electrodes, wherein the black matrix has: a first light-blocking portion positioned between the opening portions adjacent to each other in the first direction and extending in the second direction in a plan view; and a second light-blocking portion adjacent to the first light-blocking portion via the opening portions and extending in the second direction in a plan view, and a width of the second light-blocking portion in the first direction is greater than a width of the first light-blocking portion in the first direction.

### CROSS-REFERENCE TO RELATED APPLICATIONS

This application claims the benefit of priority to Japanese Patent Application Number 2025-046727 filed on Mar. 21, 2025. The entire contents of the above-identified application are hereby incorporated by reference.

### TECHNICAL FIELD

A disclosure below relates to a liquid crystal display panel and a display device.

### BACKGROUND ART

A liquid crystal display panel (also referred to as a liquid crystal panel) typically has a configuration in which a liquid crystal layer is sealed between a pair of substrates. A voltage is applied to the liquid crystal layer so that alignment of the liquid crystal molecules changes in accordance with the applied voltage. This is how an amount of transmitting light is controlled. Such a liquid crystal panel is thin in size, light in weight, and low in power consumption, and widely used for various applications. A display device developed in recent years includes a combination of a liquid crystal panel used mainly for displaying an image and another liquid crystal panel.

For example, Japanese Unexamined Patent Application Publication No. 2006-178335 discloses a liquid crystal display device using organic EL elements as a backlight. The liquid crystal display device includes: a liquid crystal display unit; and an organic EL element backlight unit. The liquid crystal display unit has: a pixel electrode provided to each of a plurality of divided pixels and including a light-transmitting portion and a light-reflective portion; and a non-display unit provided around a pixel corresponding to the pixel electrode. The organic EL element backlight unit has a positive electrode and a negative electrode one of which is sized to cover a plurality of the light-transmitting portion and configured in a divided pattern on the non-display unit and another one of which is a monolithic plate electrode.

### SUMMARY

### Technical Problem

The present disclosure sets out to provide a liquid crystal display panel with high display quality. The present disclosure also sets out to provide a display device including the liquid crystal display panel and another liquid crystal panel. According to the present disclosure, these panels can be easily positioned and a defect due to mispositioning of the panels can be eliminated.

### Solution to Problem

(1) An embodiment of the present disclosure is directed to a liquid crystal display panel including: a plurality of pixel electrodes arranged in a matrix in a first direction and a second direction intersecting with the first direction in a plan view; a liquid crystal layer; and a black matrix provided with a plurality of opening portions overlapping with the plurality of pixel electrodes. The black matrix has: a first light-blocking portion positioned between the opening portions adjacent to each other in the first direction and extending in the second direction in a plan view; and a second light-blocking portion adjacent to the first light-blocking portion via the opening portions and extending in the second direction in a plan view. A width of the second light-blocking portion in the first direction is greater than a width of the first light-blocking portion in the first direction.
(2) Regarding the liquid crystal display panel in an embodiment of the present disclosure according to the configuration (1) above, the width of the first light-blocking portion in the first direction is either a narrowest width of the first light-blocking portion in the first direction or a width of a widest region in the first light-blocking portion, and the width of the second light-blocking portion in the first direction is either a narrowest width of the second light-blocking portion in the first direction or a width of a widest region in the second light-blocking portion.
(3) Regarding the liquid crystal display panel in an embodiment of the present disclosure according to the configuration (1) or (2), the plurality of pixel electrodes has, in a plan view: a first pixel electrode; a second pixel electrode; and a third pixel electrode, all of which are provided in a stated order in the first direction. An interval between the first pixel electrode and the second pixel electrode in the first direction is longer than an interval between the second pixel electrode and the third pixel electrode in the first direction. The second light-blocking portion overlaps with a region between the first pixel electrode and the second pixel electrode. The first light-blocking portion overlaps with a region between the second pixel electrode and the third pixel electrode.
(4) The liquid crystal display panel in an embodiment of the present disclosure according to any one of the configurations (1) to (3) further includes a plurality of unit regions including the plurality of pixel electrodes, the first light-blocking portion, and the second light-blocking portion in a same layout in a plan view. The plurality of unit regions are arranged at a constant repetition pitch.
(5) Regarding the liquid crystal display panel in an embodiment of the present disclosure according to any one of the configurations (1) to (4), the plurality of opening portions has approximately a same aperture ratio.
(6) Regarding the liquid crystal display panel in an embodiment of the present disclosure according to any one of the configurations (1) to (5), the plurality of opening portions has substantially a same shape.
(7) Regarding the liquid crystal display panel in an embodiment of the present disclosure according any one of the configurations (1) to (6), the plurality of opening portions includes a first opening portion, a second opening portion, a third opening portion, and a fourth opening portion arranged in a matrix. The black matrix has a first region surrounded with the first opening portion, the second opening portion, the third opening portion, and the fourth opening portion. The liquid crystal display panel further comprises a spacer disposed to overlap with the first region. If the first region is a portion of the second light-blocking portion, a width of the first region in the first direction is substantially equal to a width of an other region in the first direction. The other region is included in the second light-blocking portion and not provided with the spacer.
(8) The liquid crystal display panel in an embodiment of the present disclosure according to any one of the configurations (1) to (7) further includes: a plurality of source lines arranged in the first direction and a plurality of gate lines arranged in the second direction in a plan view, and a plurality of unit regions including the plurality of pixel electrodes, the first light-blocking portion, and the second light-blocking portion in a same layout in a plan view. The plurality of unit regions is arranged at a constant repetition pitch, The plurality of unit regions includes a first unit region and a second unit region adjacent to each other in the first direction. The plurality of gate lines includes: a first gate line overlapping with the first light-blocking portion; and a second gate line overlapping with the second light-blocking portion. A distance between a center line of the first gate line and a center line of the second gate line is longer than a distance between center lines of two adjacent gate lines other than the second gate line among the gate lines.
(9) The liquid crystal display panel in an embodiment of the present disclosure according to any one of the configurations (1) to (8) further includes: a plurality of source lines arranged in the first direction and a plurality of gate lines arranged in the second direction in a plan view, and a plurality of unit regions including the plurality of pixel electrodes, the first light-blocking portion, and the second light-blocking portion in a same layout in a plan view. The plurality of unit regions is arranged at a constant repetition pitch. The plurality of unit regions includes a first unit region and a second unit region adjacent to each other in the first direction. The plurality of pixel electrodes includes a first pixel electrode and a second pixel electrode in a stated order in the first direction. If the first pixel electrode is included in the first unit region, and the second light-blocking portion and the second pixel electrode are included in the second unit region, the second unit region has a metal pattern disposed toward the first unit region, including a portion having a same shape as the gate line, and not intersecting with a source line.
(10) The liquid crystal display panel in an embodiment of the present disclosure according to any one of the configurations (1) to (9) further includes: a common electrode disposed to overlap with the plurality of pixel electrodes; a first insulating film provided one of above or below the common electrode; a second insulating film provided an other one of above or below the common electrode; a first contact hole provided to the first insulating film; a second contact hole provided to the second insulating film; a bridge electrode connected to the common electrode through the first contact hole; and an assist wire connected to the bridge electrode through the second contact hole. The first contact hole and the bridge electrode are disposed to overlap with the second light-blocking portion. A length of the assist wire in the second direction is greater than twice a width of the pixel electrodes in the 10 second direction.
(11) Regarding the liquid crystal display panel in an embodiment of the present disclosure according to the configuration (10), the bridge electrode does not overlap with the first light-blocking portion.
(12) Regarding the liquid crystal display panel in an embodiment of the present disclosure according to the configuration (10) or (11), the assist wire is connected to a wire for supplying a voltage to the common electrode.
(13) Regarding the liquid crystal display panel in an embodiment of the present disclosure according to any one of the configurations (10) to (12), a plurality of the second contact holes is arranged in the second direction.
(14) Regarding the liquid crystal display panel in an embodiment of present disclosure according to any one of the configurations (1) to (13), if the width of the first light-blocking portion in the first direction is set to 1, the width of the second light-blocking portion in the first direction is set to 1.2 or greater and 4 or smaller.
(15) Regarding the liquid crystal display panel in an embodiment of the present disclosure according to any one of the configurations (1) to (14), the plurality of unit regions includes a first unit region and a second unit region adjacent to each other in the first direction. Among the pixel electrodes sandwiched between the second light-blocking portion included in the first unit region and an other second light-blocking portion included in the second unit region, a number of pixel electrodes aligned in the first direction is 10 or more and 200 or fewer.
(16) An embodiment of the present disclosure is directed to a display device including: a first liquid crystal panel; and a second liquid crystal panel disposed across from the first liquid crystal panel. The first liquid crystal panel is the liquid crystal display panel according to any one of the configurations (1) to (15). In a plan view, the second liquid crystal panel has a plurality of transparent electrodes spaced apart from one another and arranged side by side in the first direction. The second light-blocking portion is disposed to overlap with a region between the plurality of transparent electrodes.
(17) Regarding the display device in an embodiment of the present disclosure according to the configuration (16), a center line of the second light-blocking portion in the first direction is substantially aligned with a center line of the region provided between the plurality of transparent electrodes in the first direction and overlapping with the second light-blocking portion.
(18) Regarding the display device in an embodiment of the present disclosure according to the configuration (16) or (17), the first liquid crystal panel has a plurality of unit regions including the plurality of pixel electrodes, the first light-blocking portion, and the second light-blocking portion in a same layout in a plan view. The plurality of unit regions is arranged at a constant repetition pitch. In a plan view, a repetition pitch of the plurality of transparent electrodes in the first direction is an integral multiple of a pitch included in the constant repetition pitch of the plurality of unit regions and disposed in the first direction.
(19) Regarding the display device in an embodiment of the present disclosure according to any one of the configurations (16) to (18), the first liquid crystal panel sequentially displays a right-eye image and a left-eye image by time switching. In synchronization with the time switching, the second liquid crystal panel controls application of a voltage to a liquid crystal layer included in the second liquid crystal panel and alters polarization states between the right-eye image and the left-eye image.
(20) Regarding the display device in an embodiment of the present disclosure according to any one of the configurations (16) to (19), the second liquid crystal panel includes a spacer. In a plan view, the spacer overlaps with the second light-blocking portion of the black matrix included in the first liquid crystal panel.

### Advantageous Effect of Disclosure

The present disclosure can provide a liquid crystal display panel with high display quality. Furthermore, the present disclosure can also provide a display device including the liquid crystal display panel and another liquid crystal panel. According to the present disclosure, these panels can be easily positioned and a defect due to mispositioning of the panels can be eliminated.

### BRIEF DESCRIPTION OF DRAWINGS

FIG. 1 is a schematic plan view illustrating a pixel configuration of a liquid crystal panel 10 according to a first embodiment;

FIG. 2 is an enlarged schematic view illustrating a portion of FIG. 1;

FIG. 3 is a schematic cross-sectional view taken along line A1-A2 in FIG. 2;

FIG. 4 is a schematic cross-sectional view taken along line B1-B2 in FIG. 2;

FIG. 5 is a schematic cross-sectional view taken along line C1-C2 in FIG. 2;

FIG. 6 is a schematic cross-sectional view taken along line D1-D2 in FIG. 2;

FIG. 7 is a schematic cross-sectional view taken along line D1-D2 in FIG. 2;

FIG. 8 is a schematic plan view of a black matrix 10B included in the liquid crystal panel 10 illustrated in FIG. 1;

FIG. 9 is a schematic plan view of the black matrix 10B included in the liquid crystal panel 10 of another example according to the first embodiment;

FIG. 10 is a schematic plan view illustrating a pixel configuration of a liquid crystal panel 10R according to a comparative embodiment;

FIG. 11 is a schematic plan view of a black matrix 10BR included in the liquid crystal panel 10R illustrated in FIG. 10;

FIG. 12 is a schematic plan view of the black matrix 10BR included in the liquid crystal panel 10R according to another comparative embodiment;

FIG. 13 is a conceptual view (a plan view) for showing a width w2 of a first region 10BN1 in a first direction 1DR, the first region 10BN1 being provided with a spacer 10PS;

FIG. 14 is a conceptual view (a plan view) for showing the width w2 of the first region 10BN1 in the first direction 1DR, the first region 10BN1 being provided with the spacer 10PS;

FIG. 15 is a schematic plan view illustrating a pixel configuration of the liquid crystal panel 10 according to a second embodiment;

FIG. 16 is an enlarged schematic view illustrating a portion of FIG. 15;

FIG. 17 is a schematic cross-sectional view taken along line C1-C2 in FIG. 16;

FIG. 18 is a schematic cross-sectional view taken along line D1-D2 in FIG. 16;

FIG. 19 is a schematic cross-sectional view taken along line D1-D2 in FIG. 16;

FIG. 20 is a schematic plan view illustrating a pixel configuration of the liquid crystal panel 10 according to a third embodiment;

FIG. 21 is an enlarged schematic view illustrating a portion of FIG. 20;

FIG. 22 is a schematic cross-sectional view taken along line C1-C2 in FIG. 20;

FIG. 23 is a schematic cross-sectional view taken along line D1-D2 in FIG. 21;

FIG. 24 is a schematic cross-sectional view taken along line D1-D2 in FIG. 21;

FIG. 25 is a schematic plan view of a common electrode 10CE shaped into a flat surface and included in a liquid crystal panel 10 according to the third embodiment;

FIG. 26 is a schematic cross-sectional view of a display device 1 according to a fourth embodiment;

FIG. 27 is a schematic plan view of the display device 1 according to the fourth embodiment, the display device 1 being observed from toward a second liquid crystal panel 20;

FIG. 28 is a schematic cross-sectional view taken along line E1-E2 in FIG. 27; and

FIG. 29 is a schematic cross-sectional view taken along line E1-E2 in FIG. 27.

### DESCRIPTION OF EMBODIMENTS

### Definition of Terms

In this Specification, the term “viewing face” means a face closer to the screen (the display surface) of either a liquid crystal panel or a display device, and the term “back face” means a face farther away from either the liquid crystal panel or the screen (the display surface) of the display device. Note that, in the schematic cross-sectional views of FIGS. 3 to 7, FIGS. 17 to 19, and FIGS. 28 and 29, the top of the drawings is to the viewing face and the bottom of the drawings is to the back face.

A no-voltage-applied state means a state in which the voltage applied to a liquid crystal layer is lower than a threshold voltage (including a state in which no voltage is applied). A voltage-applied state means a state in which the voltage applied to the liquid crystal layer is a threshold voltage or higher. In this Specification, the no-voltage-applied state is also referred to as a no-voltage-applied time, and the voltage-applied state is also referred to as a voltage-applied time.

Described below will be a liquid crystal display panel and a display device according to embodiments of the present disclosure. The present disclosure shall not be limited to the embodiments below, and the designs presented in the embodiments can be appropriately modified within a scope satisfying the configurations described in the present disclosure. Note that identical reference signs are appropriately used to denote identical or substantially identical components among the drawings. Such components will not be repeatedly elaborated upon. Aspects of the present disclosure may be appropriately combined unless otherwise departing from the scope of the present disclosure.

### First Embodiment

This embodiment relates to a liquid crystal display panel 10 (also referred to as a liquid crystal panel 10).

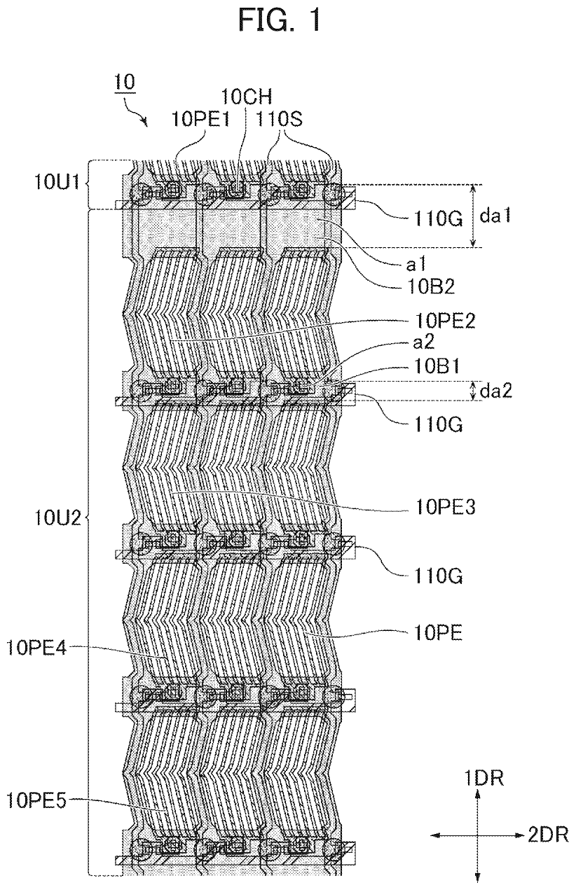

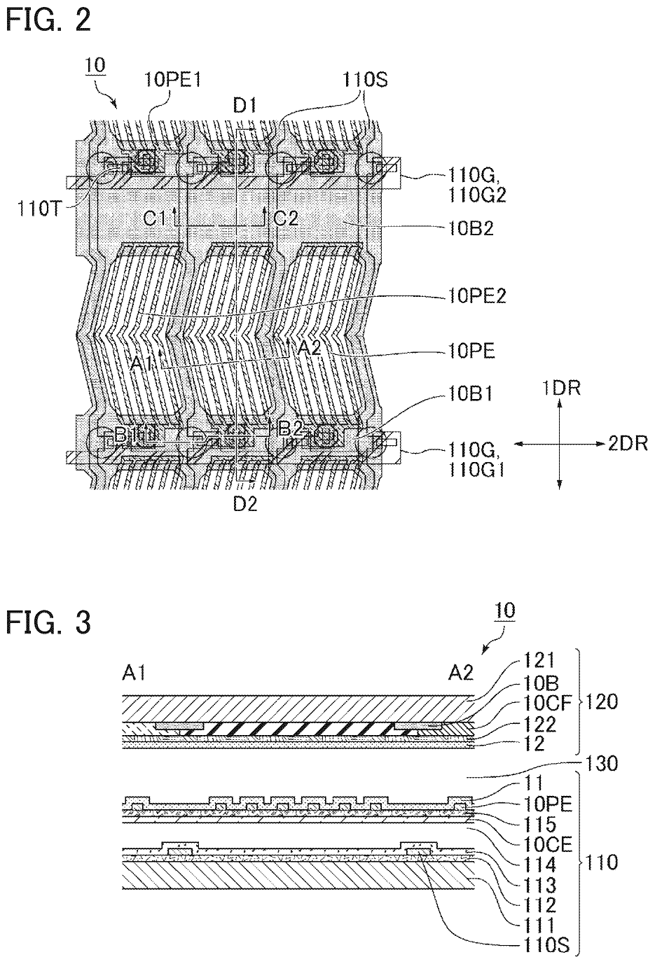

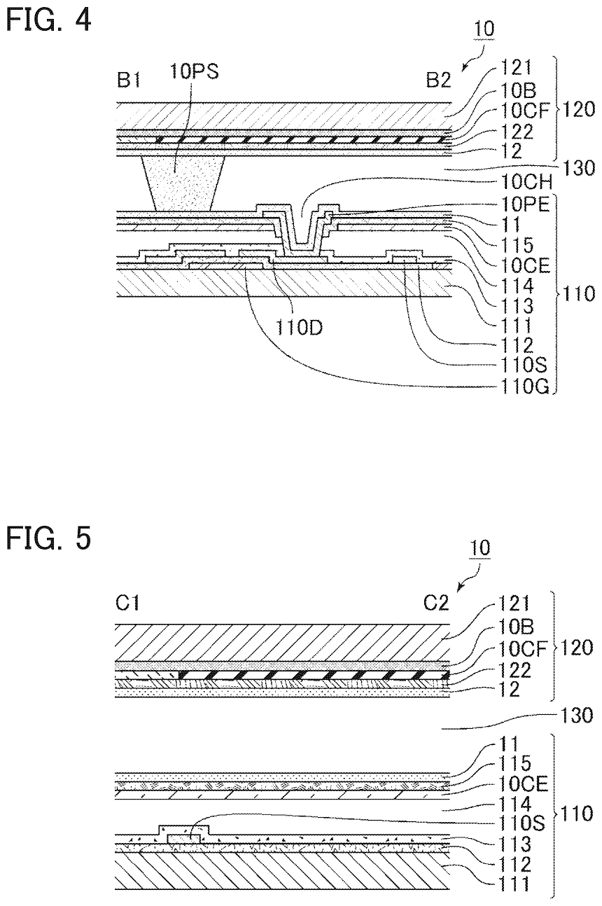

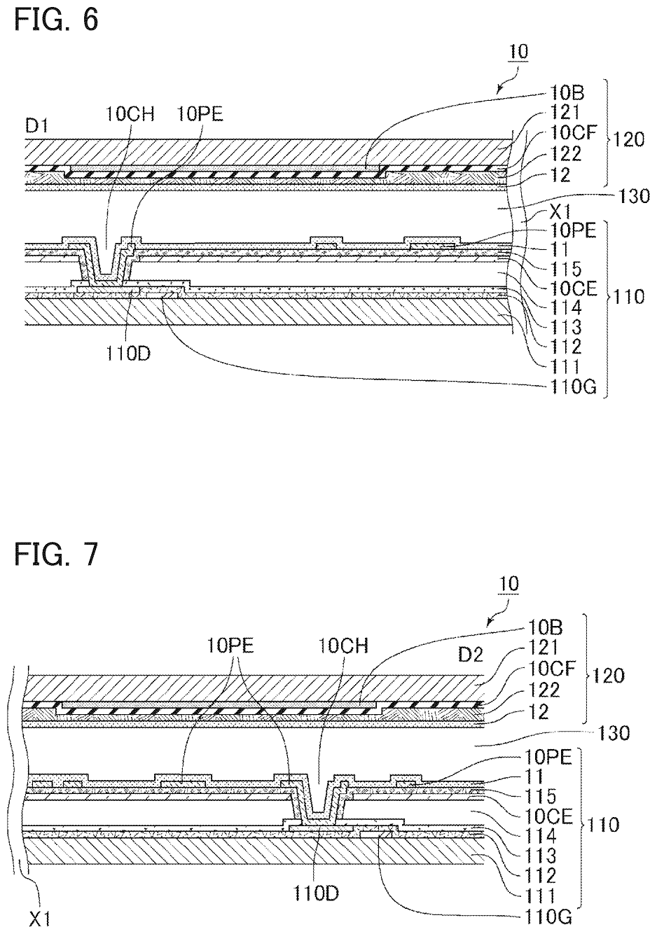

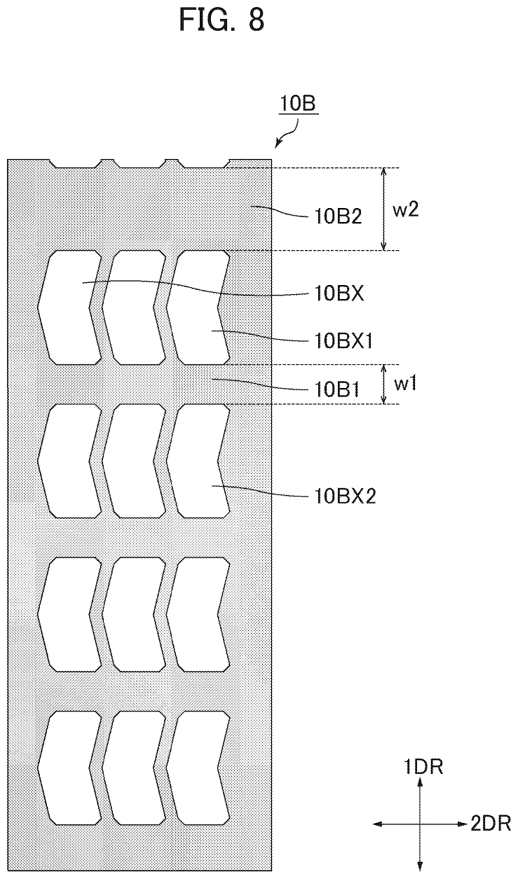

FIG. 1 is a schematic plan view illustrating a pixel configuration of the liquid crystal panel 10 according to this embodiment. FIG. 2 is an enlarged schematic view illustrating a portion of FIG. 1. FIG. 3 is a schematic cross-sectional view taken along line A1-A2 in FIG. 2. FIG. 4 is a schematic cross-sectional view taken along line B1-B2 in FIG. 2. FIG. 5 is a schematic cross-sectional view taken along line C1-C2 in FIG. 2. FIGS. 6 and 7 are schematic cross-sectional views taken along line D1-D2 in FIG. 2. Because of reasons for preparing drawings, a cross-sectional view taken along line D1-D2 is divided into, and shown in, two drawings of FIGS. 6 and 7. X1 in FIG. 6 corresponds to X1 in FIG. 7. FIG. 8 is a schematic plan view of a black matrix 10B included in the liquid crystal panel 10 illustrated in FIG. 1.

The liquid crystal panel 10 includes: a first substrate 110; a liquid crystal layer 130; and a second substrate 120, all of which are arranged in the stated order from toward the back face to toward the viewing face (see FIGS. 3 to 7). Although not shown in FIGS. 1 to 8, the liquid crystal panel 10 has, in a plan view, a display region displaying an image and a picture-frame region provided around the display region. The picture-frame region of the liquid crystal panel 10 is provided with a sealing portion 10S (also see FIG. 26 to be shown later). In this embodiment, the first substrate 110 is a TFT array substrate and the second substrate 120 is a counter substrate. However, the second substrate 120 may be a TFT array substrate and the first substrate 110 may be a counter substrate.

The liquid crystal panel 10 also includes: a plurality of pixel electrodes 10PE arranged in a matrix in a first direction 1DR and a second direction 2DR intersecting with the first direction 1DR in a plan view; a liquid crystal layer 130; and a black matrix 10B provided with a plurality of opening portions 10BX overlapping with the plurality of pixel electrodes 10PE (see, for example, FIGS. 1 and 8). The liquid crystal panel 10 further includes: a plurality of source lines (also referred to as signal lines) 110S arranged in the first direction 1DR and a plurality of gate lines (also referred to as scanning lines) 110G arranged in the second direction 2DR in a plan view (see, for example, FIG. 1). That is, in the first direction 1DR (in the vertical direction in the drawing), the plurality of source lines 110S is arranged in parallel with one another. In the second direction 2DR (in the horizontal direction in the drawing), the plurality of gate lines 110G is arranged in parallel with one another.

The plurality of source lines 110S and the plurality of gate lines 110G are formed in a matrix (also referred to as a grid pattern) as a whole so as to partition each of the pixels (see, for example FIG. 1). A minimum unit of the grid; that is, a region surrounded with one source line 110S and one gate line 110G, is referred to as a “pixel”. This “pixel” is also referred to as a subpixel. The liquid crystal panel 10 typically includes three kinds of pixels; that is, red pixels, green pixels, and blue pixels. However, the liquid crystal panel 10 may include two or fewer kinds of pixels or four or more kinds of pixels. Each of the pixels is provided with, for example, a gate line 110G, a source line 110S, a pixel electrode 10PE, a thin-film transistor (also referred to as a TFT) 110T, a contact hole 10CH, and a spacer 10PS. The black matrix 10B is provided to a lightproof region that requires the black matrix 10B, such that the liquid crystal panel 10 can ensure good quality.

In this embodiment, as will be described later, the black matrix 10B has: a first light-blocking portion 10B1; and a second light-blocking portion 10B2, each of which has a different width in the first direction 1DR. Thanks to such a feature, the liquid crystal panel 10 achieves high display quality. Furthermore, the liquid crystal panel 10 can be bonded in high precision to, for example, another second liquid crystal panel 20 (e.g., an active retarder for displaying a 3D video) while maintaining high display quality. Hence, the liquid crystal panel 10 is quite useful.

Further described below will be members included in the liquid crystal panel 10 of this embodiment. Note that, in this embodiment, the liquid crystal panel 10 is, for example, a fringe-field-switching (FFS) liquid crystal panel having: a common electrode 10CE shaped into a flat surface and disposed on a surface of a support substrate 111 toward the liquid crystal layer 130; a second interlayer insulating film 115 covering the common electrode 10CE; and the plurality of pixel electrodes 10PE arranged on a surface of the second interlayer insulating film 115 toward the liquid crystal layer 130 and provided with a slit. However, a display mode of the liquid crystal panel 10 shall not be limited to the FFS mode. The liquid crystal panel 10 may be, for example, an in-plane switching (IPS) liquid crystal panel, a vertical alignment (VA) liquid crystal panel, or a twisted nematic (TN) liquid crystal panel.

### <First Substrate>

As illustrated in, for example, FIGS. 3 to 7, the first substrate 110 includes: the support substrate 111; the plurality of gate lines 110G; a gate insulating film 112; the plurality of source lines 110S; a first interlayer insulating film 113; a planarization film 114; the common electrode 10CE; the second interlayer insulating film 115; and the plurality of pixel electrodes 10PE, all of which are provided in the stated order from toward the back face to toward the viewing face. The pixel electrodes 10 PE and the common electrode 10CE may be positioned interchangeably. The plurality of gate lines 110G is arranged in the second direction 2DR in a plan view, and the plurality of source lines 110S is arranged in the first direction 1DR in a plan view (see FIG. 1).

The plurality of gate lines 110G preferably includes: a first gate line 110G1 overlapping with the first light-blocking portion 10B1; and a second gate line 110G2 overlapping with the second light-blocking portion 10B2 (see FIG. 2). In this case, a distance between a center line of the first gate line 110G1 and a center line of the second gate line 110G2 is longer than a distance between center lines of two adjacent gate lines other than the second gate line 110G2 among the gate lines. As can be seen, in this embodiment, the arrangement of the gate lines 110G is adjusted to the widths of the first light-blocking portion 10B1 and the second light-blocking portion 10B2 included in the black matrix 10B.

Intersections of the gate lines 110G and the source lines 110S are provided with the thin-film transistors (TFTs) 110T serving as switching elements. Each of the TFTs 110T is connected to a corresponding one of the plurality of source lines 110S and to a corresponding one of the plurality of gate lines 110G. Each TFT 110T is a three-terminal switch having: a gate electrode protruding from the corresponding one gate line 110G (i.e., a portion of the gate line 110G); a source electrode protruding from the corresponding one source line 110S (i.e., a portion of the source line 110S); a drain electrode connected to a corresponding one of the plurality of pixel electrodes 10PE; and a thin-film semiconductor layer. The source electrode and the drain electrode are electrodes provided in the same layer as the source line 110S, and the gate electrode is an electrode provided in the same layer as the gate line 110G.

Each pixel electrode 10PE is disposed in a corresponding region surrounded with a pair of adjacent source lines 110S and a pair of adjacent gate lines 110G. The pixel electrode 10PE is set to a potential based on a data signal supplied through the corresponding TFT 110T. The pixel electrode 10PE is connected to the corresponding drain electrode through the contact hole 10CH.

The common electrode 10CE is formed substantially monolithically (also referred to as a monolithic electrode), regardless of the boundaries of the pixels, except for a specific portion such as a connection between a pixel electrode 10PE and a drain electrode. The common electrode 10CE is supplied with a common signal maintained at a constant value, and the common electrode 10CE is maintained at a constant potential.

In forming the pixel electrode 10PE and the common electrode 10CE, a transparent conductive material such as, for example, indium tin oxide (ITO), indium zinc oxide (IZO), zinc oxide (ZnO), or tin oxide (SnO), or an alloy of such metals, is formed into either a single layer or a multilayer by, for example, sputtering. After that, the single layer or the multilayer is patterned by photolithography to form the pixel electrode 10PE and the common electrode 10CE.

The plurality of pixel electrodes 10PE has, in a plan view: a first pixel electrode 10PE1; a second pixel electrode 10PE2; and a third pixel electrode 10PE3, all of which are provided in the stated order in the first direction 1DR (see, for example, FIG. 1). An interval da1 between the first pixel electrode 10PE1 and the second pixel electrode 10PE2 in the first direction 1DR is longer than an interval da2 between the second pixel electrode 10PE2 and the third pixel electrode 10PE3 in the first direction 1DR. In the black matrix 10B to be described later, the second light-blocking portion 10B2 overlaps with a region a1 between the first pixel electrode 10PE1 and the second pixel electrode 10PE2, and the first light-blocking portion 10B1 overlaps with a region a2 between the second pixel electrode 10PE2 and the third pixel electrode 10PE3. The interval da1 is greater than the interval da2. Hence, in the display region of the liquid crystal panel 10, areas of the pixel electrodes (pixel capacitors) are less likely to vary. Furthermore, a distance from either the gate line 110G or the source line 110S to the pixel electrode 10PE can be maintained. Hence, the liquid crystal panel 10 achieves another advantage of readily setting the parasitic capacitances to remain constant.

The interval da1 is adjusted to the width w2 of the second light-blocking portion 10B2 in the first direction 1DR. Here, the second light-blocking portion 10B2 overlaps with the region a1. The interval da2 is adjusted to the width w1 of the first light-blocking portion 10B1 in the first direction 1DR. Here, the first light-blocking portion 10B1 overlaps with the region a2. The width w1 and the width w2 will be described later.

In view of further enhancing display quality of the liquid crystal panel 10, the liquid crystal panel 10 includes a plurality of unit regions including the plurality of pixel electrodes 10PE, the first light-blocking portion 10B1, and the second light-blocking portion 10B2 in the same layout. The plurality of unit regions is arranged preferably at a constant repetition pitch. The plurality of unit regions includes a first unit region 10U1 and a second unit region 10U2 adjacent to each other in the first direction 1DR. For example, with a region having one second light-blocking portion 10B2 as one unit region, this unit region is disposed preferably repeatedly in all of the areas of the display region in the liquid crystal panel 10. In one example of this aspect, the first pixel electrode 10PE1 is included in the first unit region 10U1, and the second light-blocking portion 10B2 and the second pixel electrode 10PE2 are included in the second unit region 10U2.

In the liquid crystal panel 10 illustrated in FIG. 1, a certain unit region (i.e., the second unit region 10U2) includes, in the first direction 1DR: the region a1 between the first pixel electrode 10PE1 and the second pixel electrode 10PE2; the second pixel electrode 10PE2; the third pixel electrode 10PE3; a fourth pixel electrode 10PE4; and a fifth pixel electrode 10PE5. The first pixel electrode 10PE1, which is positioned to sandwich the region a1 with the second pixel electrode 10PE2, is included in the first unit region 10U1 adjacent to the second unit region 10U2 in the first direction 1DR. The region a1 overlaps with the second light-blocking portion 10B2 (see also FIG. 8). The region a2 between the second pixel electrode 10PE2 and the third pixel electrode 10PE3 overlaps with the first light-blocking portion 10B1.

In a case where the plurality of unit regions includes the first unit region 10U1 and the second unit region 10U2 adjacent to each other in the first direction 1DR, among the pixel electrodes 10PE sandwiched between a second light-blocking portion 10B2 included in the first unit region 10U1 and another second light-blocking portion 10B2 included in the second unit region 10U2, the number (also referred to as a sequential number n) of pixel electrodes 10PE aligned in the first direction 1DR is preferably 2 or more and 200 or fewer, and, more preferably, 10 or more and 200 or fewer. Such a liquid crystal panel 10 is more suitable in view of visibility and display quality. The sequential number n is still more preferably 20 or more and 150 or less, and particularly preferably 30 or more and 100 or less. Note that FIG. 1 exemplifies a case where the sequential number is 4. Furthermore, the number of opening portions 10BX is set to correspond to the sequential number n. The opening portions 10BX are formed on the black matrix 10B to be described later so as to align in the first direction 1DR (see FIG. 8).

### <Second Substrate 120>

As illustrated in, for example, FIGS. 3 to 7, the second substrate 120 includes: a support substrate 121; the black matrix 10B; a color filter 10CF; and a planarization film 122, all of which are provided in the stated order from toward the viewing face to toward the back face. The color filter 10CF includes, for example: a red color filter 10CFR; a blue color filter 10CFB; and a green color filter 10CFG.

The black matrix 10B includes the plurality of opening portions 10BX overlapping with the plurality of pixel electrodes 10PE. Each of the opening portions 10BX is elongated. The first direction 1DR is a longitudinal direction of each opening portion 10BX (see FIG. 8). The plurality of opening portions 10BX preferably has approximately the same aperture ratio and substantially the same shape (see FIG. 8). Furthermore, the plurality of opening portions 10BX is arranged preferably in a matrix.

Because the plurality of opening portions 10BX is provided in a matrix to the black matrix 10B, the black matrix 10B has: a portion extending in the first direction 1DR (also referred to as a first extending portion); and a portion extending in the second direction 2DR (also referred to as a second extending portion).

In the black matrix 10B, the first extending portion may extend generally in the first direction 1DR and partially in a direction different from the first direction 1DR. For example, the first extending portion may have a bending portion as long as the first extending portion extends generally in the first direction 1DR. In the black matrix 10B, the second extending portion may extend generally in the second direction 2DR and partially in a direction different from the second direction 2DR. For example, the second extending portion may have a bending portion as long as the second extending portion extends generally in the second direction 2DR.

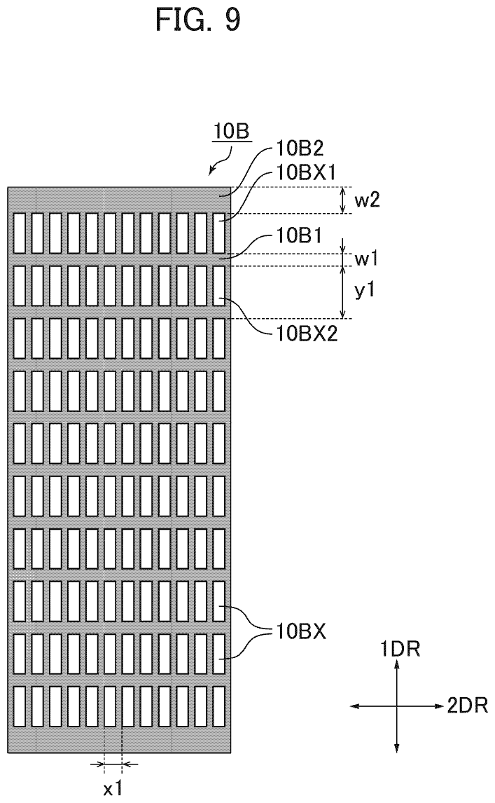

The black matrix 10B has: the first light-blocking portion 10B1; and the second light-blocking portion 10B2. The first light-blocking portion 10B1 is positioned between two opening portions 10BX adjacent to each other in the first direction 1DR, and extends in the second direction 2DR in a plan view. The second light-blocking portion 10B2 is adjacent to the first light-blocking portion 10B1 via one opening portion 10BX, and extends in the second direction 2DR in a plan view. For example, as illustrated in FIG. 9, if the first opening portion 10BX1 and the second opening portion 10BX2 are arranged in the first direction 1DR, the second extending portion positioned between the first opening portion 10BX1 and the second opening portion 10BX2 corresponds to the first light-blocking portion 10B1. In the first direction 1DR, the second extending portion adjacent to the first light-blocking portion 10B1 via the first opening portion 10BX1 corresponds to the second light-blocking portion 10B2.

In a plan view, the width w2 of the second light-blocking portion 10B2 in the first direction 1DR is greater than the width w1 of the first light-blocking portion 10B1 in the first direction 1DR. The width w1 of the first light-blocking portion 10B1 in the first direction 1DR is either a narrowest width of the first light-blocking portion 10B1 in the first direction 1DR or a widest region in the first light-blocking portion 10B1. Furthermore, the width w2 of the second light-blocking portion 10B2 in the first direction 1DR is either a narrowest width of the second light-blocking portion 10B2 in the first direction 1DR or a width of a widest region in the second light-blocking portion 10B2.

The widest region in the first light-blocking portion 10B1 is, in a plan view, a width of a portion, in the first direction 1DR, included in the first light-blocking portion 10B1 and having a largest area of a region a width of which is constant in the first direction 1DR. Likewise, the widest region in the second light-blocking portion 10B2 is, in a plan view, a width of a portion, in the first direction 1DR, included in the second light-blocking portion 10B2 and having a largest area of a region a width of which is constant in the first direction 1DR.

The black matrix 10B has: the first light-blocking portion 10B1; and the second light-blocking portion 10B2, each of which has a different width in the first direction 1DR. Such a feature provides the liquid crystal panel 10 with high display quality. In view of further enhancing the display quality, if the width w1 of the first light-blocking portion 10B1 in the first direction 1DR is set to 1, the width w2 of the second light-blocking portion 10B2 in the first direction 1DR is set to preferably 1.2 or greater and 4 or smaller, and more preferably, 1.5 or greater and 3 or smaller.

The width w2 of the second light-blocking portion 10B2 in the first direction 1DR is, for example, 40 μm or more and 100 μm or less.

Other than the first light-blocking portion 10B1 and the second light-blocking portion 10B2, light-blocking portions are provided to extend in the second direction 2DR, and each of the light-blocking portions has a width substantially the same as the width w1 of the first light-blocking portion 10B1 in the first direction 1DR.

Note that the sequential number n and the width w2 of the second light-blocking portion 10B2 in the first direction 1DR are set preferably to the extent that visibility of the user is not affected. For example, in a use environment of a final product, if a distance between the user and the screen is assumed to be short, preferably, the width w2 and the sequential number n are set smaller. Furthermore, if it is difficult to secure a sufficient aperture ratio, preferably, the sequential number n is maintained large, and, then, the position of the second light-blocking portion 10B2 is adjusted. (For example, when the liquid crystal panel 10 and the second liquid crystal panel 20 to be described later are bonded together, the black matrix 10B does not block light of all the divided portions of transparent electrodes included in the second liquid crystal panel 20. Instead, the black matrix 10B selectively blocks a center line portion included in each of the divided portions and having a large misalignment.)

The black matrix 10B may be formed of any given material as long as the material blocks light. Preferably, the material is either a resin material containing a black pigment or a metal material capable of blocking light. The black matrix 10B is formed by photolithography; that is, for example, a photosensitive resin containing a black pigment is applied, deposited, exposed to light, and developed.

FIG. 9 is a schematic plan view of the black matrix 10B included in the liquid crystal panel 10 of another example according to this embodiment. In this example, the above sequential number n is 10. Furthermore, the number of opening portions 10BX, which align in the first direction 1DR, is set to correspond to the sequential number n. In FIG. 9, for example, the second light-blocking portion 10B2 has a width w2 of 72 μm in the first direction 1DR, and the first light-blocking portion 10B1 has a width w1 of 36 μm in the first direction 1DR. Furthermore, other than the first light-blocking portion 10B1 and the second light-blocking portion 10B2, light-blocking portions are provided to extend in the second direction 2DR, and each of the light-blocking portions has a width of 36 μm.

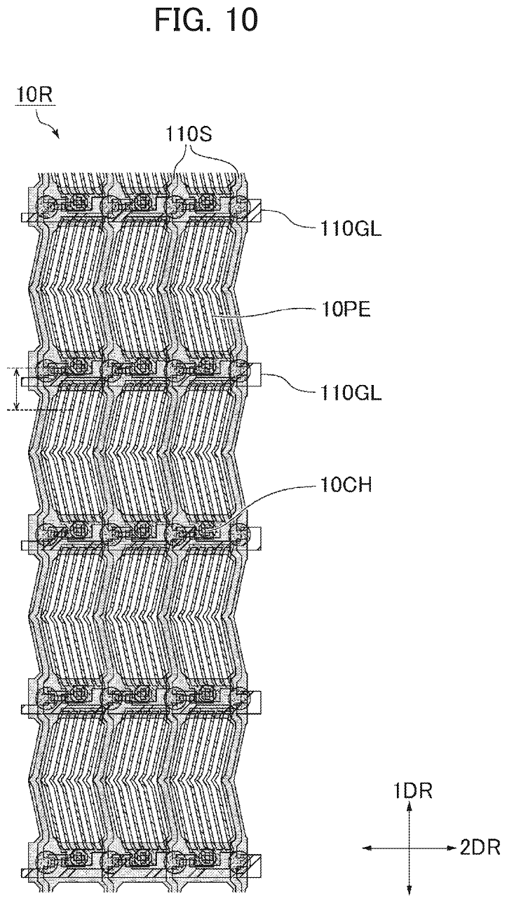

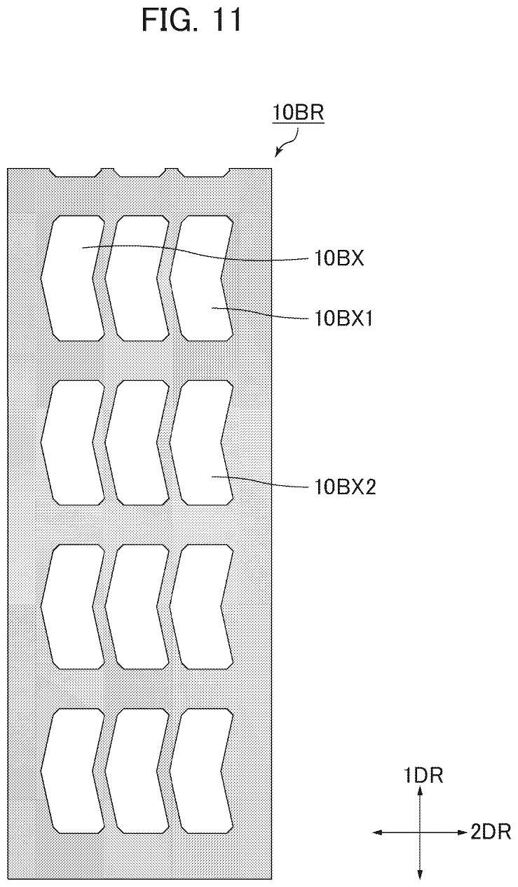

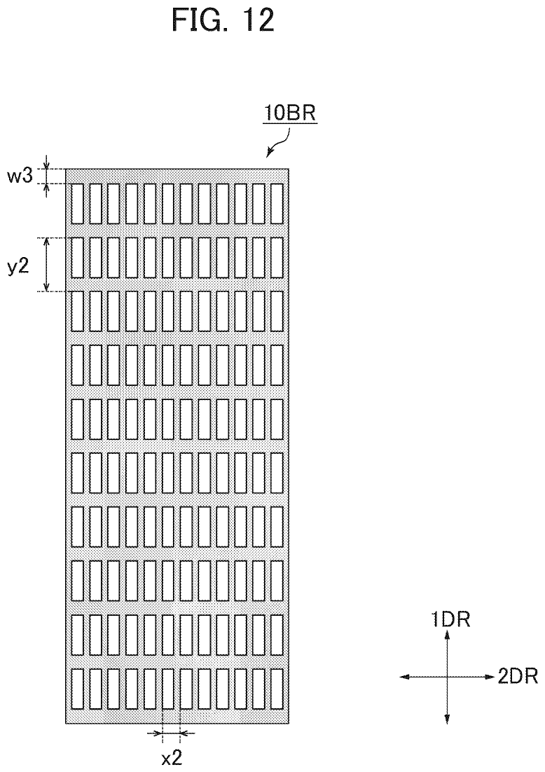

For reference, FIGS. 10 to 12 illustrate a liquid crystal panel 10R including light-blocking portions extending in the second direction 2DR, and all of the light-blocking portions have the same width (w3) in the first direction 1DR. FIG. 10 is a schematic plan view illustrating a pixel configuration of the liquid crystal panel 10R according to a comparative embodiment. FIG. 11 is a schematic plan view of a black matrix 10BR included in the liquid crystal panel 10R illustrated in FIG. 10. FIGS. 10 and 11 correspond to FIGS. 1 and 8 and exemplify a case where the sequential number n is 4. FIG. 12 is a schematic plan view of the black matrix 10BR included in the liquid crystal panel 10R according to another comparative embodiment. FIG. 12 corresponds to FIG. 9 and exemplifies a case where the sequential number n is 10. In FIG. 12, for example, each of the light-blocking portions extending in the second direction 2DR has a width w3 of 36 μm.

A length of each pixel in the first direction 1DR (i.e., y1 in FIG. 9) in this embodiment is adjusted to be shorter than a length of each pixel in the first direction 1DR (i.e., y2 in FIG. 12) in the comparative embodiment. Whereas, a length of the sequential number n pixels in the first direction 1DR (i.e., a length of one pixel in the first direction 1DR multiplied by the sequential number n) in the liquid crystal panel 10 of this embodiment is preferably the same as a length of the sequential number n pixels in the first direction 1DR (i.e., a length of one pixel in the first direction 1DR multiplied by the sequential number n) in the comparative embodiment. Furthermore, a length of each pixel in the second direction 2DR (i.e., x1 in FIG. 9) in this embodiment is preferably the same as a length of each pixel in the second direction 2DR in the comparative embodiment (i.e., x2 in FIG. 12).

### <Alignment Films 11 and 12>

The liquid crystal panel 10 may include: an alignment film (a first substrate alignment film) 11 between the first substrate 110 and the liquid crystal layer 130; and an alignment film 12 (a second substrate alignment film) 12 between the second substrate 120 and the liquid crystal layer 130.

The alignment film 11 and the alignment film 12 have a function of controlling alignment of liquid crystal molecules in the liquid crystal layer 130. If a voltage applied to the liquid crystal layer 130 is lower than a threshold voltage (including a case where no voltage is applied), essentially the alignment films 11 and 12 control the alignment of the liquid crystal molecules in the liquid crystal layer 130.

The alignment film 11 and the alignment film 12 can be formed of a typical material (referred to as an alignment film material) in the field of liquid crystal display panels. The material includes, for example: a polymer having polyimide as a main chain; a polymer having polyamic acid as a main chain; and a polymer having polysiloxane as a main chain. The alignment films 11 and 12 can be formed by application of the alignment film material. The application technique may be any given technique such as, for example, flexographic printing and ink-jet printing.

Each of the alignment film 11 and the alignment film 12 may be either a horizontal alignment film that aligns liquid crystal molecules substantially horizontally with respect to the film surface, or a vertical alignment film that aligns liquid crystal molecules substantially vertically with respect to the film surface. Furthermore, each of the alignment film 11 and the alignment film 12 may be a photoalignment film having a photofunctional group and subjected to a photoalignment treatment as the alignment treatment, a rubbed alignment film subjected to a rubbing treatment as the alignment treatment, or an alignment film not subjected to any alignment treatments.

### <Liquid Crystal Layer 130>

The liquid crystal layer 130 contains a liquid crystal material. When a voltage is applied to the liquid crystal layer 130, the liquid crystal layer 130 changes the alignment of the liquid crystal molecules in the liquid crystal material in accordance with the applied voltage and controls the amount of light to be transmitted through the liquid crystal layer 130. As to the liquid crystal molecules, dielectric constant anisotropy (Δε), which is defined by an equation (L) below, may take either a positive value or a negative value.

Δε=(a dielectric constant of the liquid crystal molecules in the major axis direction)−(a dielectric constant of the liquid crystal molecules in the minor axis direction) (L)

Liquid crystal molecules exhibiting positive dielectric constant anisotropy are also referred to as positive liquid crystals, and liquid crystal molecules exhibiting negative dielectric constant anisotropy are also referred to as negative liquid crystals. Note that a major axis direction of the liquid crystal molecules is a slow axis direction. The liquid crystal molecules are homogeneously aligned in a state where no voltage is applied (i.e., in a no-voltage applied state). In the no-voltage applied state, the direction of the major axis of the liquid crystal molecules is also referred to as an initial alignment direction of the liquid crystal molecules

### <Spacer 10PS>

The liquid crystal panel 10 may include the spacer 10PS. The spacer 10PS has a function of leaving a clearance for a space in which the liquid crystal layer 130 is formed. For example, the spacer 10PS may be provided to the second substrate 120 and may have a distal end in contact with the first substrate 110 or not. However, preferably, the distal end is in contact with the first substrate 110. The spacer 10PS is also referred to as a main spacer. The liquid crystal panel 10 of this embodiment preferably has a plurality of the spacers 10PS.

Each of the spacers 10PS is shaped into, for example, a column. A planar shape of each spacer 10PS may be, for example, polygonal, circular, or elliptical. The spacer 10PS preferably contains, for example, a cured photosensitive resin product. Example of the photosensitive resin includes a resin having an ultraviolet reactive functional group.

The spacer 10PS may be disposed only at a position overlapping with the second light-blocking portion 10B2. Such a feature makes it possible to sufficiently reduce light leakage and alignment abnormality. Hence, the liquid crystal panel 10 can efficiently block light from reaching a lightproof region.

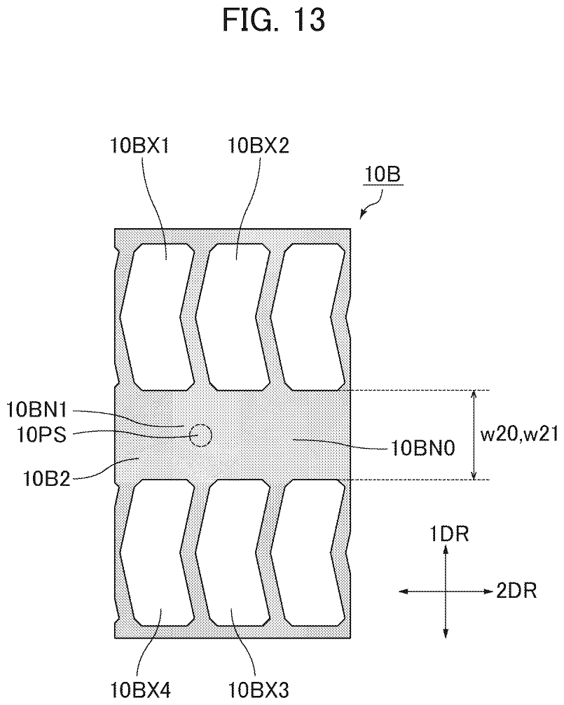

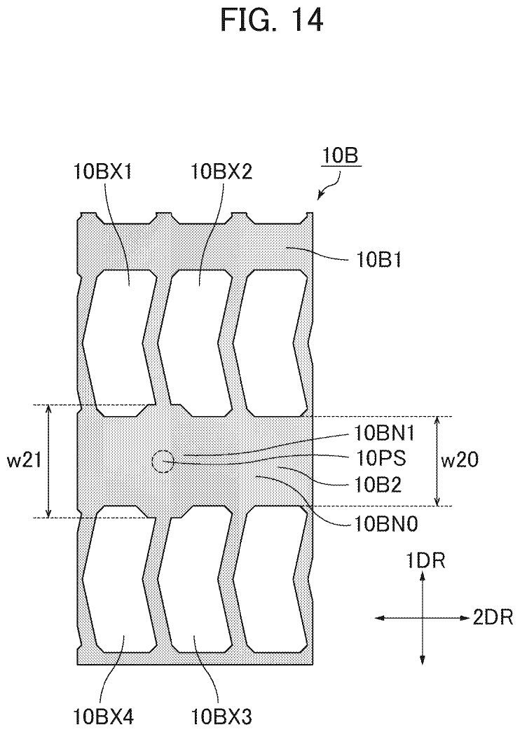

Here, if the plurality of opening portions 10BX includes a first opening portion 10BX1, a second opening portion 10BX2, a third opening portion 10BX3, and a fourth opening portion 10BX4 arranged in a matrix, the black matrix 10B has a first region 10BN1 surrounded with the first opening portion 10BX1, the second opening portion 10BX2, the third opening portion 10BX3, and the fourth opening portion 10BX4 (see FIGS. 13 and 14). The first opening portion 10BX1 and the second opening portion 10BX2 are adjacent to each other in the second direction 2DR, and the third opening portion 10BX3 and the fourth opening portion 10BX4 are adjacent to each other in the second direction 2DR. The second opening portion 10BX2 and the third opening portion 10BX3 are adjacent to each other in the first direction 1DR, and the first opening portion 10BX1 and the fourth opening portion 10BX4 are adjacent to each other in the first direction 1DR.

The liquid crystal panel 10 preferably has the spacer 10PS disposed to overlap with the first region 10BN1. For example, as illustrated in FIG. 13, if the first region 10BN1 in which the spacer 10PS is provided is a portion of the second light-blocking portion 10B2, a width w21 of the first region 10BN1 in the first direction 1DR is preferably substantially equal to a width w20 of an other region 10BN0 in the first direction 1DR. The other region 10BN0 is included in the second light-blocking portion 10B2 and not provided with the spacer 10PS. Such a feature further improves visibility of the liquid crystal panel 10. For reference, FIG. 13 illustrates an embodiment in which the width w21 is substantially equal to the width w20, and FIG. 14 conceptually illustrates an embodiment in which the width w21 is longer than the width w20. FIGS. 13 and 14 are conceptual views for showing the width w2 of the first region 10BN1 in the first direction 1DR, the first region 10BN1 being provided with the spacer 10PS. Both of the drawings are plan views.

If the first region in which the spacer 10PS is provided is not a portion of the second light-blocking portion 10B2 (e.g., if the first light-blocking portion 10B1 is provided with the spacer 10PS), a width of the first region in the first direction 1DR may be, or may not be, substantially equal to a width of another region in the first direction 1DR. The other region is included in the first light-blocking portion 10B1 and not provided with the spacer 10PS.

### Second Embodiment

In this embodiment, features unique to this embodiment will be mainly described, and features overlapping with those in the first embodiment will be omitted. The liquid crystal panel 10 of this embodiment is substantially the same as the liquid crystal panel 10 of the first embodiment except that a metal pattern 110M is disposed to the second unit region 10U2 toward the first unit region 10U1.

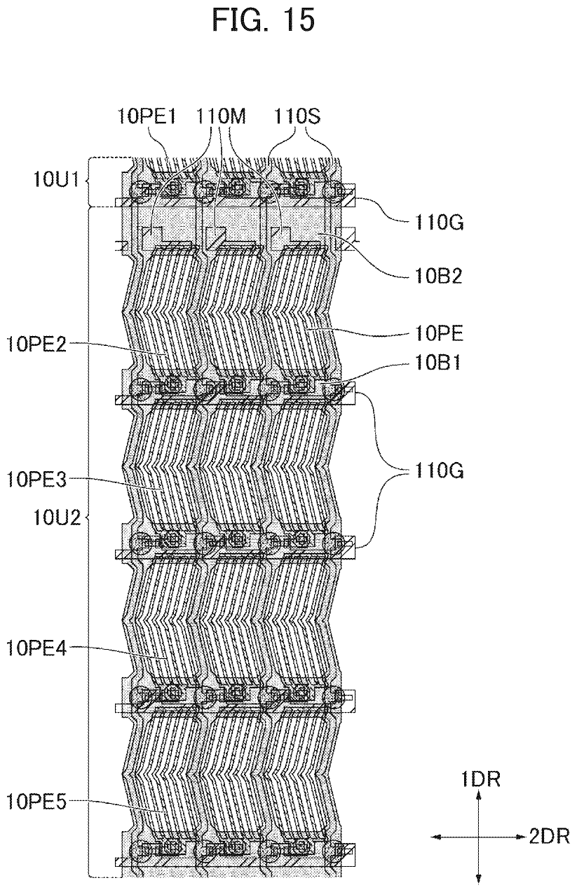

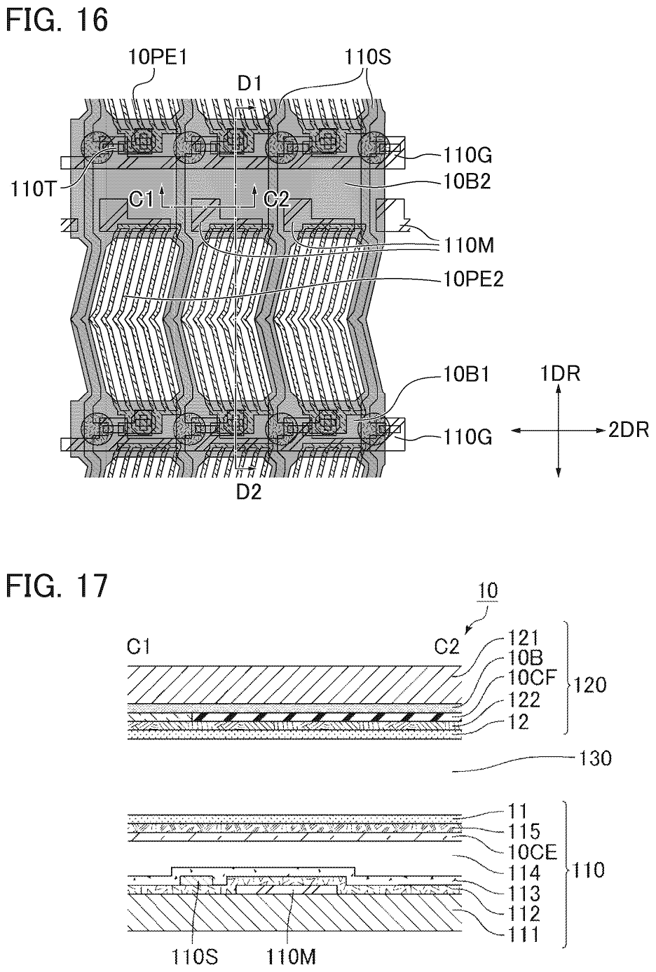

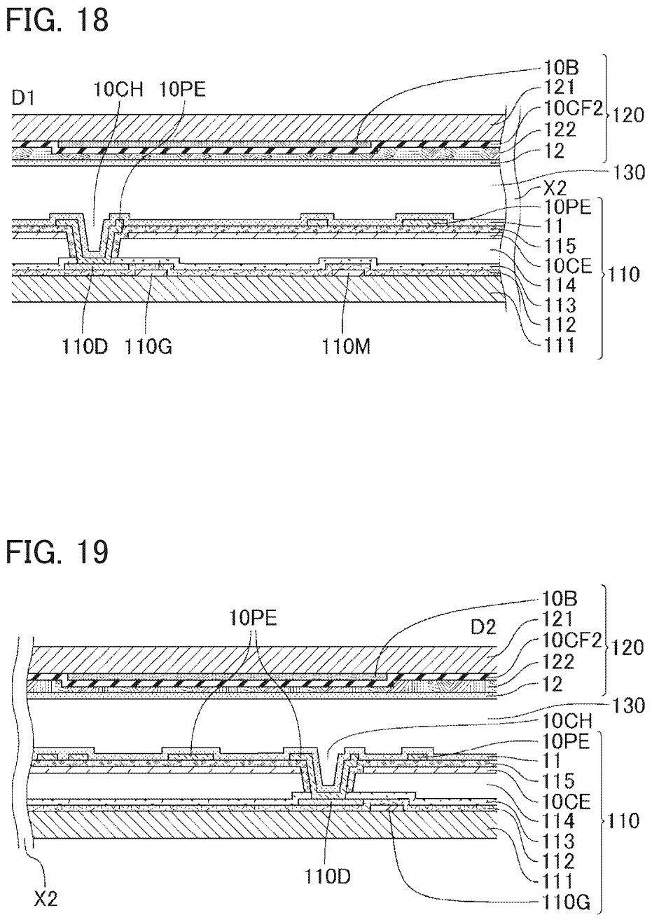

FIG. 15 is a schematic plan view illustrating a pixel configuration of the liquid crystal panel 10 according to this embodiment. FIG. 16 is an enlarged schematic view illustrating a portion of FIG. 15. FIG. 17 is a schematic cross-sectional view taken along line C1-C2 in FIG. 16. FIGS. 18 and 19 are schematic cross-sectional views taken along line D1-D2 in FIG. 16. Because of reasons for preparing drawings, a cross-sectional view taken along line D1-D2 is divided into, and shown in, two drawings of FIGS. 18 and 19. X2 in FIG. 18 corresponds to X2 in FIG. 19.

Similar to the liquid crystal panel 10 of the first embodiment, the liquid crystal panel 10 of this embodiment includes, in a plan view, the plurality of source lines 110S in the first direction 1DR and the plurality of gate lines 110G in the second direction 2DR. The liquid crystal panel 10 of this embodiment includes a plurality of unit regions 10U including the plurality of pixel electrodes 10PE, the first light-blocking portion 10B1, and the second light-blocking portion 10B2 in the same layout in a plan view. The plurality of unit regions 10U is arranged at a constant repetition pitch. The plurality of unit regions 10U includes the first unit region 10U1 and the second unit region 10U2 adjacent to each other in the first direction 1DR. The first pixel electrode 10PE1 is included in the first unit region 10U1, and the second light-blocking portion 10B2 and the second pixel electrode 10PE2 are included in the second unit region 10U2 (see FIG. 15).

Whereas, as illustrated in FIGS. 15 to 19, the liquid crystal panel 10 of this embodiment is different from the liquid crystal panel 10 of the first embodiment in that the second unit region 10U2 has the metal pattern 110M disposed toward the first unit region 10U1. Specifically, the metal pattern 110M is disposed to the region a1 provided between the first pixel electrode 10PE1 and the second pixel electrode 10PE2 and overlapping with the second light-blocking portion 10B2. The metal pattern 110M is disposed toward the second pixel electrode 10PE2 (see, in particular, FIGS. 15 and 16). The metal pattern 110M includes a portion having the same shape as a gate line 110G and does not intersect with a source line 110S.

For example, at a step of bonding the first substrate 110 and the second substrate 120 together, a bonding displacement could occur. In this embodiment, even if the second substrate 120 including the black matrix 10B is displaced in the first direction 1DR when disposed, the metal pattern 110M includes a portion having the same shape as the gate line 110G. Such a feature sufficiently reduces variations in aperture ratio between a pixel adjacent to the second light-blocking portion 10B2 and a pixel adjacent to a light-blocking portion other than the second light-blocking portion 10B2. The metal pattern 110M does not necessarily have the same shape as the gate line 110G, and may have a floating island shape as illustrated in FIG. 16. Furthermore, the metal pattern 110M does not intersect with the source line 110S, thereby keeping a bus line capacitance from increasing.

A metal material for forming the metal pattern 110M may be any given metal material, and may be, for example, the same as the metal material used for forming the gate line 110G.

### Third Embodiment

In this embodiment, features unique to this embodiment will be mainly described, and features overlapping with those in the first embodiment will be omitted. The liquid crystal panel 10 of this embodiment is substantially similar to the liquid crystal panel 10 of the first embodiment except that the former liquid crystal panel 10 further includes an assist wire 110A connected to the common electrode 10CE through at least two contact holes.

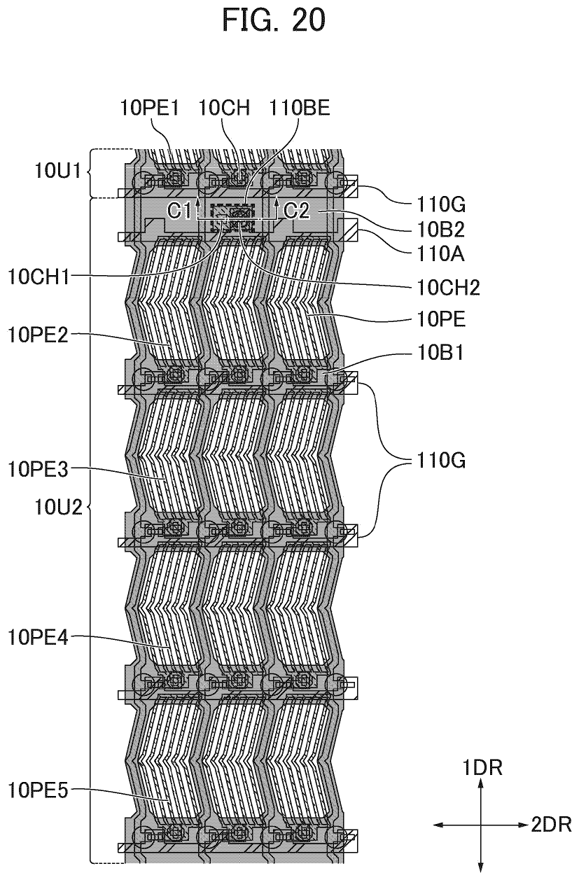

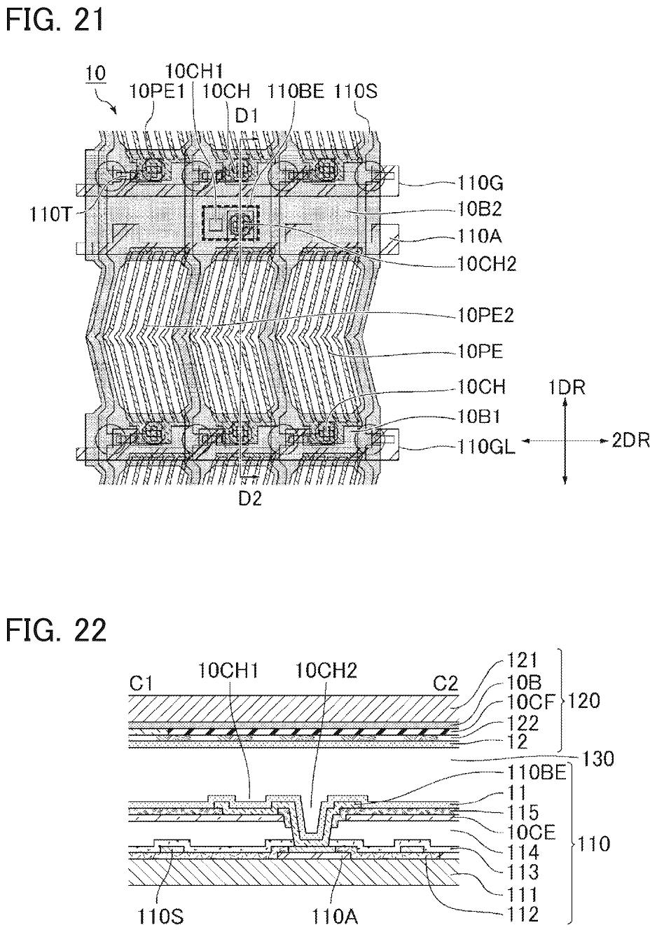

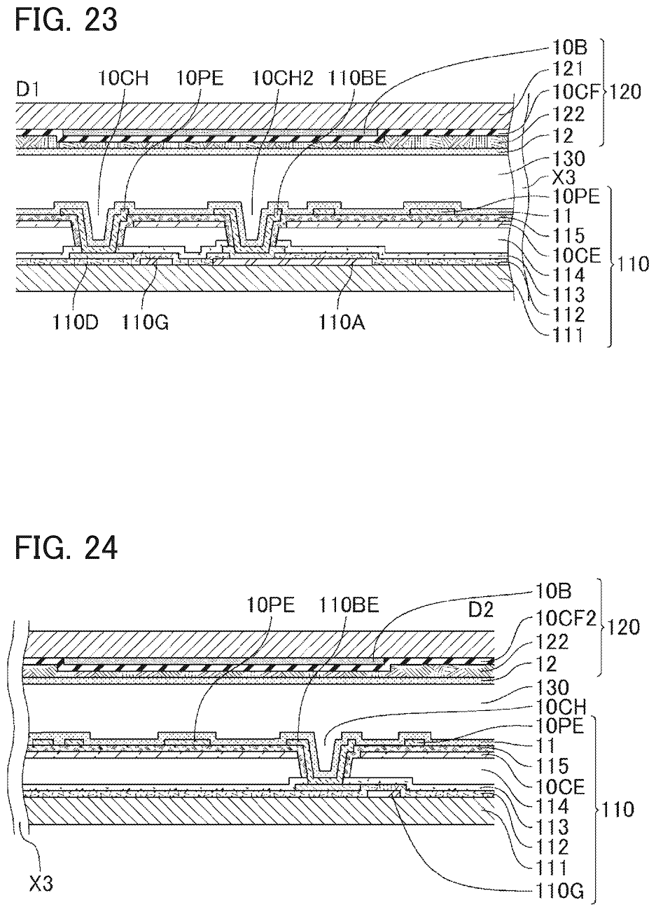

FIG. 20 is a schematic plan view illustrating a pixel configuration of the liquid crystal panel 10 according to this embodiment. FIG. 21 is an enlarged schematic view illustrating a portion of FIG. 20. FIG. 22 is a schematic cross-sectional view taken along line C1-C2 in FIG. 20. FIGS. 23 and 24 are schematic cross-sectional views taken along line D1-D2 in FIG. 21. Because of reasons for preparing drawings, a cross-sectional view taken along line D1-D2 is divided into, and shown in, two drawings of FIGS. 23 and 24. X3 in FIG. 23 corresponds to X3 in FIG. 24.

The liquid crystal panel 10 of this embodiment includes: the common electrode 10CE disposed to overlap with the plurality of pixel electrodes 10PE; a first insulating film (e.g., the second interlayer insulating film 115) provided one of above or below the common electrode 10CE; a second insulating film (e.g., the planarization film 114) provided an other one of above or below the common electrode 10CE; a first contact hole 10CH1 provided to the first insulating film (e.g., the second interlayer insulating film 115); a second contact hole 10CH2 provided to the second insulating film (e.g., the planarization film 114); a bridge electrode 110BE connected to the common electrode 10CE through the first contact hole 10CH1; and an assist wire 110A connected to the bridge electrode 110BE through the second contact hole 10CH2 (see FIGS. 20 to 24).

As illustrated in FIGS. 20 and 21, the first contact hole 10CH1 and the bridge electrode 110BE are disposed to overlap with the second light-blocking portion 10B2. The bridge electrode 110BE preferably does not overlap with the first light-blocking portion 10B1. The second contact hole 10CH2 is disposed to preferably overlap with the second light-blocking portion 10B2. More specifically, the first contact hole 10CH1, the bridge electrode 110BE, and the second contact hole 10CH2 are all disposed preferably in the region a1 provided between the first pixel electrode 10PE1 and the second pixel electrode 10PE2 and overlapping with the second light-blocking portion 10B2. Furthermore, the assist wire 110A is disposed preferably in the region a1 toward the second pixel electrode 10PE2 (see, in particular, FIGS. 20 and 21).

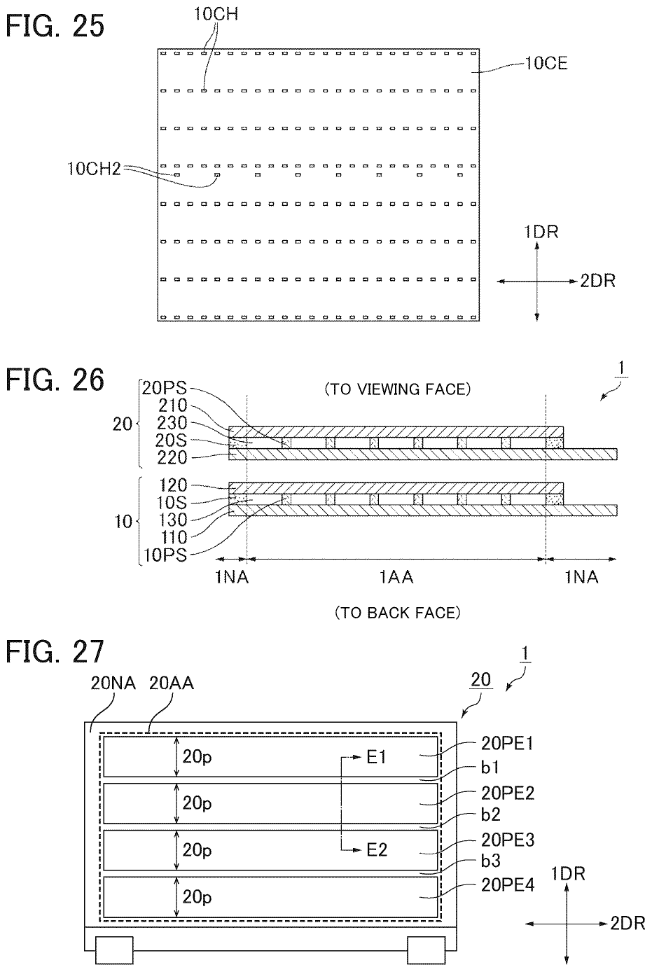

Preferably, a plurality of the second contact holes 10CH2 is arranged in the second direction 2DR. As illustrated in FIG. 25, in this embodiment, the contact holes 10CH are provided along the gate lines 110G, and the second contact holes 10CH2 are provided in the second direction 2DR so as to overlap with the second light-blocking portion 10B2. FIG. 25 is a schematic plan view of the common electrode 10CE shaped into a flat surface and included in the liquid crystal panel 10 of this embodiment.

The assist wire 110A is connected preferably to the bridge electrode 110BE through the second contact hole 10CH2 and to a wire for supplying a voltage to the common electrode 10CE.

The assist wire 110A preferably includes a portion having the same shape as a gate line 110G. Hence, for example, even if the second substrate 120, including the black matrix 10B in the second embodiment, is displaced in the first direction 1DR when disposed, the assist wire 110A includes a portion having the same shape as the gate line 110G. Such a feature sufficiently reduces variations in aperture ratio between a pixel adjacent to the second light-blocking portion 10B2 and a pixel adjacent to a light-blocking portion other than the second light-blocking portion 10B2.

A length of the assist wire 110A in the second direction 2DR is greater than twice a width of the pixel electrodes 10PE in the second direction 2DR (see FIGS. 20 and 21). For example, when a metal line is disposed in the region a1 toward the second pixel electrode 10PE2 so as to cross two or more pixels in the second direction 2DR in a plan view, the metal line can serve as the assist wire 110A having the above length. The assist wire 110A may intersect with the source lines 110S or not. The assist wire 110A may overlap with the pixel electrodes 10PE or not in a plan view.

The assist wire 110A is a metal line. A metal material for forming the assist wire 110A may be any given metal material, and may be, for example, the same as the metal material used for forming the gate line 110G.

The liquid crystal panel 10 further includes the assist wire 110A, so that resistance of the common electrode 10CE is sufficiently lowered. That is, the in-plane resistance distribution is sufficiently reduced. As a result, for example, if the liquid crystal panel 10 of this embodiment is a large panel (e.g., the screen size is approximately 30 to 100 inches), the liquid crystal panel 10 can lower the resistance of the common electrode 10CE without an additional wiring layer and sufficiently reduce display unevenness. In this case, the effect of lowering the resistance of the common electrode 10CE is greater as the above sequential number n is smaller (e.g., as an arrangement rate of the second light-blocking portion 10B2 is higher) despite a decrease in the aperture ratio as a tradeoff.

### Fourth Embodiment

This embodiment relates to a display device 1 including: a first liquid crystal panel 10; and a second liquid crystal panel 20 disposed across from the first liquid crystal panel 10.

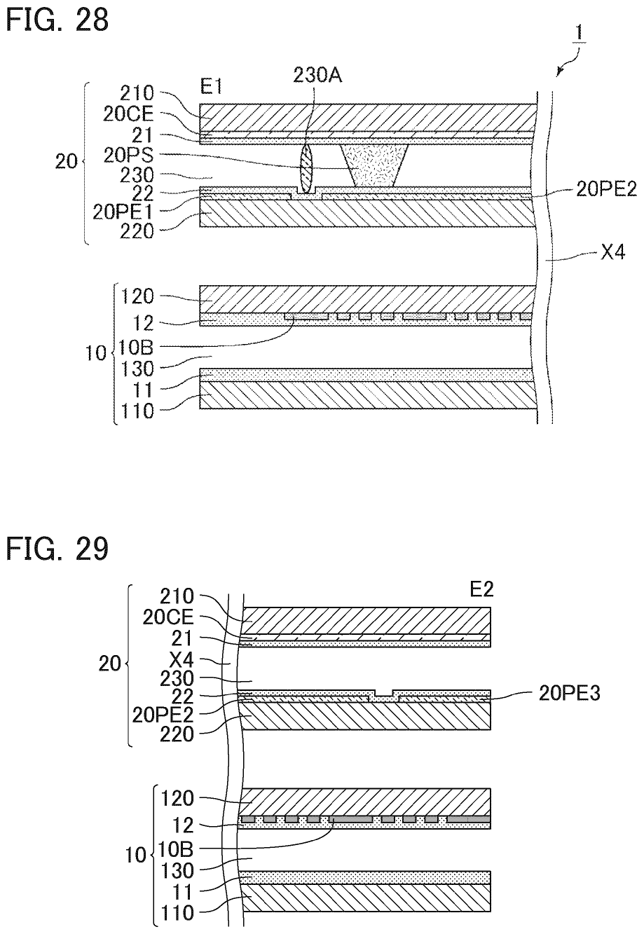

FIG. 26 is a schematic cross-sectional view of the display device 1 of this embodiment. FIG. 27 is a schematic plan view of the display device 1 observed from toward the second liquid crystal panel 20. FIGS. 28 and 29 are schematic cross-sectional views taken along line E1-E2 in FIG. 27. Because of reasons for preparing drawings, a cross-sectional view taken along line E1-E2 is divided into, and shown in, two drawings of FIGS. 28 and 29. X4 in FIG. 28 corresponds to X4 in FIG. 29. In FIGS. 28 and 29, the first liquid crystal panel 10 and the second liquid crystal panel 20 are spaced apart from each other. However, the first liquid crystal panel 10 and the second liquid crystal panel 20 may be in contact with each other.

As illustrated in FIG. 26, the display device 1 of this embodiment includes the first liquid crystal panel 10 and the second liquid crystal panel 20 in the stated order from toward the back face to toward the viewing face. The display device 1 includes: a display region 1AA displaying an image; and a picture-frame region 1NA provided around the display region 1AA. The display device 1 may further include an optical member such as a polarizing plate or a phase difference plate, and may further include a light source. As an example, such a display device includes: a light source for a backlight; a polarizing plate; the first liquid crystal panel 10; a polarizing plate; the second liquid crystal panel 20; and a polarizing plate, all of which are provided in the stated order from toward the back face to toward the viewing face.

### [First Liquid Crystal Panel 10]

The first liquid crystal display panel 10; that is, a liquid crystal display panel of the present disclosure, is the liquid crystal panel 10 of the first, second, or third embodiment. The first liquid crystal panel 10 includes: a display region displaying an image; and a picture-frame region provided around the display region. The picture-frame region of the first liquid crystal panel 10 is provided with a sealing portion 10S (see FIG. 26). As to details of the first liquid crystal panel 10, see the corresponding details of the liquid crystal panel 10 described above. The first liquid crystal panel 10 is also referred to as a main panel 10.

### [Second Liquid Crystal Panel 20]

The second liquid crystal panel 20 may be simpler in configuration than the first liquid crystal panel 10. The second liquid crystal panel 20 includes, for example: a transparent electrode formed as a pair of substrates; a liquid crystal material sealed between the pair of substrates; and a spacer to maintain a cell thickness. The second liquid crystal panel 20 is also referred to as a subpanel 20.

As illustrated in FIG. 26, if the main panel 10 for displaying an image is disposed to the back face of the subpanel 20, the subpanel 20 preferably includes: a pair of transparent electrodes having a fixed pattern capable of controlling alignment of liquid crystals in a specific planar shape alone in the display region (or a monolithic pattern capable of collectively controlling alignment of the liquid crystals in the entire display region); and a liquid crystal layer sandwiched between the pair of transparent electrodes. Thanks to such an embodiment, the display device 1 can be provided with a viewing-angle control function and a 3D function.

For example, in the display device 1 of FIGS. 26 to 29, the second liquid crystal panel 20 includes: a first substrate 210; a liquid crystal layer 230; and a second substrate 220, all of which are arranged in the stated order from toward the viewing face to toward the back face. The second liquid crystal panel 20 includes: a display region 20AA displaying an image; and a picture-frame region 20NA provided around the display region 20AA. The picture-frame region 20NA of the second liquid crystal panel 20 is provided with a sealing portion 20S. From the viewpoint of further reducing a defect due to mispositioning of the first liquid crystal panel 10 and the second liquid crystal panel 20, the display region 20AA of the second liquid crystal panel 20 is preferably larger than the display region of the first liquid crystal panel 10.

Further described below will be members included in the second liquid crystal panel 20.

### <First Substrate 210>

The substrate 210 includes a support substrate and a first substrate electrode 20CE in the stated order to toward the liquid crystal layer 230. The second substrate 220 includes a support substrate and a second substrate electrode 20PE in the stated order to toward the liquid crystal layer 230. The second liquid crystal panel 20 does not include any gate lines, source lines, or TFTs. The second liquid crystal panel 20 does not have any configurations corresponding to “pixels” of the first liquid crystal panel 10. Furthermore, the second liquid crystal panel 20 preferably does not have such a light-blocking body as a black matrix included in the display region 20AA.

The first substrate electrode 20CE is shaped into a flat surface and provided to the display region 20AA. The first substrate electrode 20CE is maintained at a constant potential and functions as a common electrode. The first substrate electrode 20CE is, for example, a transparent electrode.

The second substrate electrode 20PE is shaped into a flat surface (shaped monolithically), provided to the display region 20AA, and divided. The second substrate 20PE functions as a segment electrode. More specifically, in a plan view, the second substrate electrodes 20PE is a plurality of transparent electrodes spaced apart from one another and arranged side by side in the first direction 1DR. Thus, in a plan view, the second liquid crystal panel 20 has a plurality of transparent electrodes 20PE spaced apart from one another and arranged side by side in the first direction 1DR (see FIG. 27). As illustrated in FIG. 27, the second liquid crystal panel 20 has four transparent electrodes (i.e., numerical signs 20PE1, 20PE2, 20PE3, and 20PE4) spaced apart from one another and arranged side by side. As will be described later, the second light-blocking portion 10B2 of the black matrix 10B included in the first liquid crystal panel 10 is disposed to overlap with a region between the plurality of transparent electrodes 20PE.

In forming the first substrate electrode 20CE and the second substrate electrodes 20PE, a transparent conductive material such as, for example, indium tin oxide (ITO), indium zinc oxide (IZO), zinc oxide (ZnO), or tin oxide (SnO), or an alloy of such metals, is formed into either a single layer or a multilayer by, for example, sputtering. After that, the single layer or the multilayer is patterned by photolithography to form the first substrate electrode 20CE and the second substrate electrodes 20PE.

### <Alignment Films 21 and 22>

The second liquid crystal panel 20 may include: an alignment film 21 (a first substrate alignment film) between the first substrate 210 and the liquid crystal layer 230; and an alignment film 22 (a second substrate alignment film) between the second substrate 220 and the liquid crystal layer 230.

The alignment film 21 and the alignment film 22 have a function of controlling alignment of liquid crystal molecules in the liquid crystal layer 230. If a voltage applied to the liquid crystal layer 230 is lower than a threshold voltage (including a case where no voltage is applied), essentially the alignment films 21 and 22 control the alignment of the liquid crystal molecules in the liquid crystal layer 230. As to details of the alignment films, see the corresponding details of the alignment films 11 and 12 included in the first liquid crystal panel 10.

### <Liquid Crystal Layer 230>

The liquid crystal layer 230 contains a liquid crystal material. When a voltage is applied to the liquid crystal layer 230, the liquid crystal layer changes the alignment of the liquid crystal molecules in the liquid crystal material in accordance with the applied voltage and controls the amount of light to be transmitted through the liquid crystal layer 230. The liquid crystal molecules may be either positive liquid crystal molecules or negative liquid crystal molecules.

### <Spacer 20PS>

The second liquid crystal panel 20 may include a spacer 20PS. The spacer 20PS has a function of leaving a clearance for a space in which the liquid crystal layer 230 is formed. For example, the spacer 20PS may be provided to the first substrate 210 and may have a distal end in contact with the second substrate 220 or not. However, preferably, the distal end is in contact with the second substrate 220. The second liquid crystal panel 20 preferably has a plurality of the spacers 20PS. As to shapes and materials of the spacers 20P, see the corresponding shapes and materials of the spacers 10P according to the first embodiment.

For example, in a plan view, the spacer 20PS overlaps with the second light-blocking portion 10B2 of the black matrix 10B included in the first liquid crystal panel 10.

### [Display Device 1]

As to the display device 1 of this embodiment, the second light-blocking portion 10B2 of the black matrix 10B included in the first liquid crystal panel 10 is disposed to overlap with a region between the plurality of transparent electrodes 20PE included in the second liquid crystal panel 20. The first liquid crystal panel 10 and the second liquid crystal panel 20 are bonded together in such a layout. Hence, the first display device 1 is formed. In particular, a center line of the second light-blocking portion 10B2 in the first direction 1DR is substantially aligned preferably with a center line of a region provided between the plurality of transparent electrodes 20PE in the first direction 1DR and overlapping with the second light-blocking portion 10B2.

In a display device with a main panel and a subpanel combined together, a monolithic transparent electrode of the subpanel is not formed integrally over the entire display region. Instead, the transparent electrode could be divided so as to correspond to a plurality of pixels of the main panel. The display device reduces loads on the transparent electrodes arranged to correspond to the respective display regions. Thanks to such a feature, the alignment of the liquid crystals in the subpanel can be controlled to catch up with the timing of writing an image to the main panel. Whereas, if the transparent electrode of the subpanel is divided, a horizontal line might be observed as a display defect because the liquid crystals are not aligned in a preferable state in a portion between the divided transparent electrodes (i.e., a portion in which no transparent electrode is found). For example, in a black screen or a dark screen, a stripe of bright portion could be observed. In this case, the divided portion between the transparent electrodes of the subpanel is preferably overlapped with a light-blocking body (e.g., the black matrix) of the main panel. However, in such a case, the main panel and the subpanel could be mispositioned when bonded together such that the divided portion between the transparent electrodes of the subpanel might extend off a portion included in the main panel and provided with the black matrix.

Whereas, in the display device 1 of this embodiment, as can be seen, the second light-blocking portion 10B2 having a wide width in the first direction 1DR overlaps with a region between the plurality of transparent electrodes 20PE included in the second liquid crystal panel 20. Such a display device 1 successfully exhibits an advantageous effect of the divided transparent electrodes in the second liquid crystal panel 20 to maintain high display quality, and, simultaneously, overcomes the display defect described above. Hence, the display device 1 is extremely useful.

As described above, the liquid crystal panel 10 includes the plurality of unit regions 10U including the plurality of pixel electrodes 10PE, the first light-blocking portion 10B1, and the second light-blocking portion 10B2 in the same layout. The plurality of unit regions is arranged preferably at a constant repetition pitch 10p. In a plan view, a repetition pitch 20p of the plurality of transparent electrodes 20PE included in the second liquid crystal panel 20 in the first direction 1DR is preferably an integral multiple of a pitch included in the repetition pitch 10p of the plurality of unit regions 10U and disposed in the first direction 1DR. Thanks to such a feature, the display device 1 can further exhibit the advantageous effect of maintaining high display quality and simultaneously overcoming display quality. As a preferable example of such an aspect, the repetition pitch 20p is substantially the same as (i.e., one time as) the repetition pitch 10p.

The repetition pitch 10p is a length of one unit region 10U in the first direction 1DR included in the plurality of unit regions 10U including the plurality of pixel electrodes 10PE, the first light-blocking portion 10B1, and the second light-blocking portion 10B2 in the same layout. The repetition pitch 20p is a length of one transparent electrode 20PE in the first direction 1DR included in the plurality of transparent electrodes 20PE in the second liquid crystal panel 20.

In the display device 1 illustrated in FIG. 27, if the repetition pitch 20p is one time the repetition pitch 10p, for example, a second light-blocking portion 10B2(1) of the first liquid crystal panel 10 is disposed to overlap with a region b1 between the first transparent electrode 20PE1 and the second transparent electrode 20PE2 in FIG. 27. Another second light-blocking portion 10B2(2) adjacent to the second light-blocking portion 10B2(1) in the first direction 1DR (i.e., a second light-blocking portion 10B2 included in another unit region adjacent to the unit region including the second light-blocking portion 10B2(1) in the first direction 1DR) is disposed to overlap with a region b2 between the second transparent electrode 20PE2 and the third transparent electrode 20PE3. Another second light-blocking portion 10B2(3) adjacent to the second light-blocking portion 10B2(2) in the first direction 1DR away from the second light-blocking portion 10B2(1) (i.e., a second light-blocking portion 10B2 included in another unit region adjacent to the unit region including the second light-blocking portion 10B2(2) in the first direction 1DR away from the unit region including the second light-blocking portion 10B2(1)) is disposed to overlap a region b3 between the third transparent electrode 20PE3 and the fourth transparent electrode 20PE4.

### First Modification of Fourth Embodiment

In a fourth embodiment, the first substrate electrode 20CE functions as a common electrode and the second substrate electrode 20PE functions as a segment electrode. Alternatively, the first substrate electrode 20CE may function as a segment electrode and the second substrate electrode 20PE may function as a common electrode. In this example, the first substrate electrode 20CE functions as a segment electrode and the second substrate electrode 20PE functions as a common electrode. In this example, in a plan view, the first substrate electrode 20CE corresponds to a plurality of transparent electrodes spaced apart from one another and arranged side by side in the first direction 1DR.

### Second Modification of Fourth Embodiment

The display device 1 of the fourth embodiment includes the second liquid crystal panel 20 and the first liquid crystal panel 10 in the stated order from toward the back face to toward the viewing face. Alternatively, the first liquid crystal panel 10 and the second liquid crystal panel 20 may be arranged in the reverse order. The display device 1 of this modification includes the second liquid crystal panel 20 and the first liquid crystal panel 10 in the stated order from toward the back face to toward the viewing face. As can be seen, if the second liquid crystal panel 20 is disposed to the back face and the first liquid crystal panel 10 is disposed to the viewing face, the second liquid crystal panel 20 is preferably an active matrix liquid crystal panel having no color filter. In such an aspect, the display device 1 can present higher contrast.

### Fifth Embodiment

In this embodiment, features unique to this embodiment will be mainly described, and features overlapping with those in the fourth embodiment (or the first or the second modification of the fourth embodiment) will be omitted. The display device 1 of this embodiment is substantially the same as the display device of the fourth embodiment (or the first or the second modification of the fourth embodiment) except that the second liquid crystal panel 20 is limited to an active retarder for displaying a 3D image.

In the display device 1 of this embodiment, the first liquid crystal panel 10 sequentially displays a right-eye image and a left-eye image by time switching. In synchronization with the time switching, the second liquid crystal panel 20 controls application of a voltage to a liquid crystal layer 230 included in the second liquid crystal panel 20 and alters polarization states between the right-eye image and the left-eye image. Using, for example, polarization glasses, the viewer can separately view the left-eye image and the right-eye image from toward the second liquid crystal panel 20. That is, the display device 1 of this embodiment can display a 3D image. In particular, in this embodiment, one of the right-eye image or the left-eye image is displayed preferably in a normally white mode and the other is displayed preferably in a normally black mode.

As can be seen, the embodiments of present disclosure have been described. All of the individual matters described above are applicable throughout present disclosure.

Described below are further details of the present disclosure, with reference to examples. However, the present disclosure shall not be limited to such examples.

### First Example

This example relates to the display device 1 corresponding to the fourth embodiment (see FIGS. 26 to 29). In this example, the first liquid crystal panel 10 of the first embodiment was used (see FIGS. 1 to 9).

In this example, a basic pixel size in a plan view was set to 50 μm×150 μm, and an aperture ratio of a standard design pixel was set to 60.8%.

Each of the portions included in the black matrix 10B of the first liquid crystal panel 10 was set to have a width below. All of the widths are lengths in a plan view.
(1) The second light-blocking portion 10B2 in the first direction 1DR had a width w2 of 72 μm in the first direction 1DR.
(2) A light-blocking portion (including the first light-blocking portion 10B1) other than the second light-blocking portion 10B2 and extending in the second direction 2DR had a width of 36 μm in the first direction 1DR.
(3) A light-blocking portion extending in the first direction 1DR had a width of 10 μm in the second direction 2DR (i.e., a width between two opening portions 10BX in the second direction 2DP).

For each panel used as the first liquid crystal panel 10, the sequential number n and the repetition pitch 10p were set as shown in Table 1. The second liquid crystal panel 20 was designed so that the repetition pitch 20p was an integer multiple of the repetition pitch 10p of the first liquid crystal panel 10 to be combined with the second liquid crystal panel 20. For example, a display device No. 6 shown in Table 1 was prepared by bonding the first liquid crystal panel 10 having n=64 and a repetition pitch 10p=9600 μm and the second liquid crystal panel 20 having a repetition pitch 20p=(9600 μm×an integer multiple).

For the display devices 1 prepared using the liquid crystal panels 10 shown in Table 1, aperture ratios on a standard pixel were obtained. Table 1 shows the results. In Table 1, the “Opening Area Adjustment (μm)” is obtained as follows: a value is obtained by subtracting a width w0 of a light-blocking portion (including the first light-blocking portion 10B1) other than the second light-blocking portion 10B2 and extending in the second direction 2DR from the width w2 of the second light-blocking portion 10B2 in the first direction 1DR, and the obtained value is divided by the sequential number (i.e., “(w2−w0)/sequential number”). The “Pixel Aperture Ratio (rectangular calculation)” is an aperture ratio calculated on the assumption that each of the pixels is rectangular. The “Ratio of Pixel Aperture Ratio to Standard Pixel Aperture Ratio” is obtained by dividing a value of a “Pixel Aperture Ratio” by an aperture ratio of the standard design pixel (i.e., 60.8).

TABLE 1

| | First Liquid | | | | Ratio of Pixel |
|---|---|---|---|---|---|
| | Crystal Panel 10 | | Opening | Pixel | Aperture Ratio |
| | | Repetition | Area | Aperture | to Standard |
| | Sequential | Pitch | Adjustment | Ratio | Pixel Aperture |
| | Number. n | (μm) | (μm) | (%) | Ratio (%) |
| No. 1 | 2 | 300 | 18.0 | 51.2 | 84.2 |
| No. 2 | 4 | 600 | 9.0 | 56.0 | 92.1 |
| No. 3 | 8 | 1200 | 4.5 | 58.4 | 96.1 |
| No. 4 | 16 | 2400 | 2.3 | 59.6 | 98.0 |
| No. 5 | 32 | 4800 | 1.1 | 60.2 | 99.0 |
| No. 6 | 64 | 9600 | 0.6 | 60.5 | 99.5 |

Table 1 shows that the larger the sequential number n of the first liquid crystal panel 10 is; that is, the larger the number of pixels sandwiched between two second light-blocking portions 10B2 adjacent to each other in the first direction 1DR is, the smaller the difference in the aperture ratio is between a pixel and the standard design pixel. As a result, a reduction in transmittance can be reduced. This is probably because an area of the aperture area, which could be reduced by a width increased in the first direction 1DR by the second light-blocking portion 10B2, can be divided among many pixels.

As to the display device 1 of this example, the second light-blocking portion 10B2 included in the black matrix 10B of the first liquid crystal panel 10 and having a great width in the first direction 1DR can block light from a region included in the second liquid crystal panel 20 and having liquid crystals misaligned (i.e., a portion without the transparent electrode 20PE). Such a feature can sufficiently keep the portion without the transparent electrode 20PE from extending off the black matrix 10B of the first liquid crystal panel 10. As a result, the display device 1 can reduce decreases in transmittance (aperture ratio) and display quality.

### Second Example

This example relates to the display device 1 corresponding to the fourth embodiment (see FIGS. 26 to 29). In this example, the first liquid crystal panel 10 of the second embodiment was used (see FIGS. 15 to 19).

In the display device 1 of this example, the metal pattern 110M is disposed in the region a1 overlapping with the second light-blocking portion 10B2. Hence, the display device 1 can sufficiently reduce variations in aperture ratio that might occur when misalignment develops between the layers of the first liquid crystal panel 10.

### Third Example

This example relates to the display device 1 corresponding to the fourth embodiment (see FIGS. 26 to 29). In this example, the first liquid crystal panel 10 of the third embodiment was used (see FIGS. 20 to 25).

The display device 1 of this example includes the assist wire 110A connected to the common electrode 10CE through at least two contact holes 10CH (at least the first contact hole 10CH1 and the second contact hole 10CH2). Hence, the display device 1 can reduce resistance of the common electrode CE included in the first liquid crystal panel 10, and, simultaneously, sufficiently reduce variations in aperture ratio that might occur when misalignment develops between the layers of the first liquid crystal panel 10.

The aspects of the present disclosure described above may be appropriately combined unless otherwise departing from the scope of present disclosure.

1. A liquid crystal display panel, comprising:
a plurality of pixel electrodes arranged in a matrix in a first direction and a second direction intersecting with the first direction in a plan view; a liquid crystal layer; and a black matrix provided with a plurality of opening portions overlapping with the plurality of pixel electrodes,
wherein the black matrix has: a first light-blocking portion positioned between the opening portions adjacent to each other in the first direction and extending in the second direction in a plan view; and a second light-blocking portion adjacent to the first light-blocking portion via the opening portions and extending in the second direction in a plan view, and
a width of the second light-blocking portion in the first direction is greater than a width of the first light-blocking portion in the first direction.

2. The liquid crystal display panel according to claim 1,
wherein the width of the first light-blocking portion in the first direction is either a narrowest width of the first light-blocking portion in the first direction or a width of a widest region in the first light-blocking portion, and
the width of the second light-blocking portion in the first direction is either a narrowest width of the second light-blocking portion in the first direction or a width of a widest region in the second light-blocking portion.

3. The liquid crystal display panel according to claim 1,
wherein the plurality of pixel electrodes has, in a plan view: a first pixel electrode; a second pixel electrode; and a third pixel electrode, all of which are provided in a stated order in the first direction,
an interval between the first pixel electrode and the second pixel electrode in the first direction is longer than an interval between the second pixel electrode and the third pixel electrode in the first direction,
the second light-blocking portion overlaps with a region between the first pixel electrode and the second pixel electrode, and
the first light-blocking portion overlaps with a region between the second pixel electrode and the third pixel electrode.

4. The liquid crystal display panel according to claim 1, further comprising
a plurality of unit regions including the plurality of pixel electrodes, the first light-blocking portion, and the second light-blocking portion in a same layout in a plan view, the plurality of unit regions being arranged at a constant repetition pitch.

5. The liquid crystal display panel according to claim 1,
wherein the plurality of opening portions has approximately a same aperture ratio.

6. The liquid crystal display panel according to claim 1,
wherein the plurality of opening portions has substantially a same shape.

7. The liquid crystal display panel according to claim 1,
wherein the plurality of opening portions includes a first opening portion, a second opening portion, a third opening portion, and a fourth opening portion arranged in a matrix,
the black matrix has a first region surrounded with the first opening portion, the second opening portion, the third opening portion, and the fourth opening portion,
the liquid crystal display panel further comprises a spacer disposed to overlap with the first region, and
if the first region is a portion of the second light-blocking portion, a width of the first region in the first direction is substantially equal to a width of an other region in the first direction, the other region being included in the second light-blocking portion and not provided with the spacer.

8. The liquid crystal display panel according to claim 1, further comprising:
a plurality of source lines arranged in the first direction and a plurality of gate lines arranged in the second direction in a plan view; and
a plurality of unit regions including the plurality of pixel electrodes, the first light-blocking portion, and the second light-blocking portion in a same layout in a plan view, the plurality of unit regions being arranged at a constant repetition pitch,
wherein the plurality of unit regions includes a first unit region and a second unit region adjacent to each other in the first direction,
the plurality of gate lines includes: a first gate line overlapping with the first light-blocking portion; and a second gate line overlapping with the second light-blocking portion, and
a distance between a center line of the first gate line and a center line of the second gate line is longer than a distance between center lines of two adjacent gate lines other than the second gate line among the gate lines.

9. The liquid crystal display panel according to claim 1, further comprising:
a plurality of source lines arranged in the first direction and a plurality of gate lines arranged in the second direction in a plan view; and
a plurality of unit regions including the plurality of pixel electrodes, the first light-blocking portion, and the second light-blocking portion in a same layout in a plan view, the plurality of unit regions being arranged at a constant repetition pitch,
wherein the plurality of unit regions includes a first unit region and a second unit region adjacent to each other in the first direction,
the plurality of pixel electrodes includes a first pixel electrode and a second pixel electrode in a stated order in the first direction, and
if the first pixel electrode is included in the first unit region, and the second light-blocking portion and the second pixel electrode are included in the second unit region,
the second unit region has a metal pattern disposed toward the first unit region, including a portion having a same shape as the gate line, and not intersecting with a source line.

10. The liquid crystal display panel according to claim 1, further comprising:
a common electrode disposed to overlap with the plurality of pixel electrodes; a first insulating film provided one of above or below the common electrode; a second insulating film provided an other one of above or below the common electrode; a first contact hole provided to the first insulating film; a second contact hole provided to the second insulating film; a bridge electrode connected to the common electrode through the first contact hole; and an assist wire connected to the bridge electrode through the second contact hole,
wherein the first contact hole and the bridge electrode are disposed to overlap with the second light-blocking portion, and
a length of the assist wire in the second direction is greater than twice a width of the pixel electrodes in the second direction.

11. The liquid crystal display panel according to claim 10,
wherein the bridge electrode does not overlap with the first light-blocking portion.

12. The liquid crystal display panel according to claim 10,
wherein the assist wire is connected to a wire for supplying a voltage to the common electrode.

13. The liquid crystal display panel according to claim 10,
wherein a plurality of the second contact holes is arranged in the second direction.

14. The liquid crystal display panel according to claim 1,
wherein if the width of the first light-blocking portion in the first direction is set to 1, the width of the second light-blocking portion in the first direction is set to 1.2 or greater and 4 or smaller.

15. The liquid crystal display panel according to claim 4,
wherein the plurality of unit regions includes a first unit region and a second unit region adjacent to each other in the first direction, and
among the pixel electrodes sandwiched between the second light-blocking portion included in the first unit region and an other second light-blocking portion included in the second unit region, a number of pixel electrodes aligned in the first direction is 10 or more and 200 or fewer.

16. A display device, comprising:
a first liquid crystal panel; and a second liquid crystal panel disposed across from the first liquid crystal panel,
wherein the first liquid crystal panel is the liquid crystal display panel according to claim 1,
in a plan view, the second liquid crystal panel has a plurality of transparent electrodes spaced apart from one another and arranged side by side in the first direction, and
the second light-blocking portion is disposed to overlap with a region between the plurality of transparent electrodes.

17. The display device according to claim 16,
wherein a center line of the second light-blocking portion in the first direction is substantially aligned with a center line of the region provided between the plurality of transparent electrodes in the first direction and overlapping with the second light-blocking portion.

18. The display device according to claim 16,
wherein the first liquid crystal panel has a plurality of unit regions including the plurality of pixel electrodes, the first light-blocking portion, and the second light-blocking portion in a same layout in a plan view, the plurality of unit regions being arranged at a constant repetition pitch, and
in a plan view, a repetition pitch of the plurality of transparent electrodes in the first direction is an integral multiple of a pitch included in the constant repetition pitch of the plurality of unit regions and disposed in the first direction.

19. The display device according to claim 16,
wherein the first liquid crystal panel sequentially displays a right-eye image and a left-eye image by time switching, and
in synchronization with the time switching, the second liquid crystal panel controls application of a voltage to a liquid crystal layer included in the second liquid crystal panel and alters polarization states between the right-eye image and the left-eye image.

20. The display device according to claim 16,
wherein the second liquid crystal panel includes a spacer, and
in a plan view, the spacer overlaps with the second light-blocking portion of the black matrix included in the first liquid crystal panel.
